(19) United States
(12) Patent Application Publication
(10) Pub. No.: US 2014/0220930 A1
(43) Pub. Date: Aug. 7, 2014

(54) GIFTING PREPAID DATA PLANS

(71) Applicant: Gigsky, Inc., Palo Alto, CA (US)

(72) Inventor: Ravi Rishy Maharaj, Palo Alto, CA (US)

(73) Assignee: GIGSKY, INC., Palo Alto, CA (US)

(21) Appl. No.: 14/171,751

(22) Filed: Feb. 3, 2014

Related U.S. Application Data
(60) Provisional application No. 61/759,660, filed on Feb. 1, 2013.

(51) Int. Cl. H04M 15/00; H04M 17/00

(52) U.S. Cl. CPC H04M 15/09; H04M 17/00
USPC 455/406

(57) ABSTRACT

A method is provided for allowing a user to gift a portion of a prepaid plan. A server offers the gifted portion of the prepaid plan to another user. In an embodiment, the other user may be a charity, a user chosen by the purchaser of the prepaid plan, a user chosen by the entity running the server, for example.

### CROSS-REFERENCE TO RELATED APPLICATIONS

This application claims priority to U.S. Provisional Patent Application No. 61/759,660 (Docket # AZ-8), entitled “GIFTING PREPAID DATA PLANS,” filed Feb. 1, 2013, by Ravi Rishy-Maharaj, which is incorporated herein by reference in its entirety. Additionally, this application incorporates by reference,

U.S. Provisional Patent Application No. 61/759,399 (Docket # AZ-6), entitled “Secure Over the Air SIM provisioning,” filed Feb. 1, 2013, by Ravi Rishy-Maharaj et al.;

U.S. Provisional Patent Application No. 61/759,691 (Docket # AZ-7), entitled “GLOBAL e-MARKETPLACE FOR MOBILE SERVICES,” filed Feb. 1, 2013, by Ravi Rishy-Maharaj et al.; U.S. Provisional Patent Application No. 61/759,660 (Docket # AZ-8), entitled “GIFTING PREPAID DATA PLANS,” filed Feb. 1, 2013, by Ravi Rishy-Maharaj et al.;

U.S. Provisional Patent Application No. 61/489,636 (Docket # AZ-1), filed May 24, 2011, “SYSTEMS AND METHODS FOR REUSING A SUBSCRIBER IDENTITY MODULE FOR MULTIPLE NETWORKS,” by Ravi Rishy-Maharaj;

U.S. Provisional Patent Application No. 61/489,228 (Docket # AZ-2), entitled “DEVICES AND SYSTEMS THAT OBTAIN AND MANAGE SUBSCRIPTIONS FOR ACCESSING WIRELESS NETWORKS ON AN AD HOC BASIS AND METHODS OF USE,” filed May 23, 2011, by Ravi Rishy-Maharaj;

U.S. patent application Ser. No. 13/480,343 (Docket # AZ-3) entitled, “DEVICES AND SYSTEMS THAT OBTAIN AND MANAGE SUBSCRIPTIONS FOR ACCESSING WIRELESS NETWORKS ON AN AD HOC BASIS AND METHODS OF USE,” filed May 24, 2012, by Ravi Rishy-Maharaj; and

U.S. patent application Ser. No. 13/479,091 (Docket # AZ-4), entitled, “DEVICES AND SYSTEMS THAT OBTAIN AND MANAGE SUBSCRIPTIONS FOR ACCESSING WIRELESS NETWORKS ON AN AD HOC BASIS AND METHODS OF USE,” filed May 23, 2012, by Ravi Rishy-Maharaj.

All of the above applications are incorporated herein by reference in their entirety.

### FIELD

This specification generally relates to providing wireless service to users.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

One may purchase a phone service, and then later discover that the phone service is no longer needed, but the purchaser still retains the right to use data left on the plan, that purchaser is unlikely to use, which leads to a waste of the remaining right to download data. The user and the company from which the user purchased the data have bandwidth that neither can use.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1A shows a block diagram of an embodiment of a system for providing wireless phone service in multiple locations in which a user may gift unused phone service.

FIG. 1B shows a block diagram of an example of wireless system.

FIG. 2A shows a block diagram of an example of machine having wireless capabilities.

FIG. 2B shows a block diagram of an embodiment of functions associated with a GUI/app stored in memory carried out by the machine having wireless capabilities.

FIG. 2C is a flowchart of an embodiment of a method of gifting unused services of a prepaid plan.

FIG. 2D is a flowchart of an embodiment of a method of implementing an market place for selling plans of carriers.

FIG. 3 shows a flowchart of an embodiment of a method for gifting unused services from the point of view of the user, via a wireless phone service that is available in multiple locations in which that are not all covered by the same phone service.

FIG. 4 shows a flowchart of an embodiment of a method for gifting unused services from the point of view of the server point of view, via a wireless phone service in multiple locations that are not all covered by the same phone service.

FIG. 5 shows a flowchart of an embodiment of a method for receiving a service gifted by another user from the point of view of the user, in a system for providing wireless phone service in multiple locations that are not all covered by the same phone service.

FIG. 6 shows a flowchart of an embodiment of a method for allocating a service gifted by another user from the point of view of the carrier or server, a system for providing wireless phone service in multiple locations that are not all covered by the same phone service.

FIG. 7A shows a flowchart of an embodiment of method for a carrier to choose the types of plans and prices the carrier would like to offer, via server of FIG. 1A, from the point of view of the carrier.

FIG. 7B shows a flowchart of an embodiment of method for a carrier to choose the types of plans and prices the carrier would like to offer, via the server of FIG. 1A, from the point of view of the server.

FIG. 7C shows a graph of an embodiment of pages of an application or GUI for gifting.

FIG. 7D shows a graph of an embodiment of pages of an application or GUI for a carrier.

FIG. 8 shows an example of a sign-in/sign-up page for a marketplace service that provides mobile phone service.

FIG. 9 shows a screenshot of an example of a page for a carrier to manage carrier accounts.

FIG. 10 shows a screenshot of an example of a page for a carrier to choose plans and prices for wireless services that are offered to consumers, prior to updating the prices and plans.

FIG. 11 shows a screenshot of an example of a page for a carrier to choose plans and prices for wireless services that are offered to consumers, after updating the prices and plans.

FIG. 12 shows a screenshot of an example of a page shown to the carrier after the carrier has submitted the update to prices and plans.

FIG. 13 shows a screenshot of an example of page showing account information.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

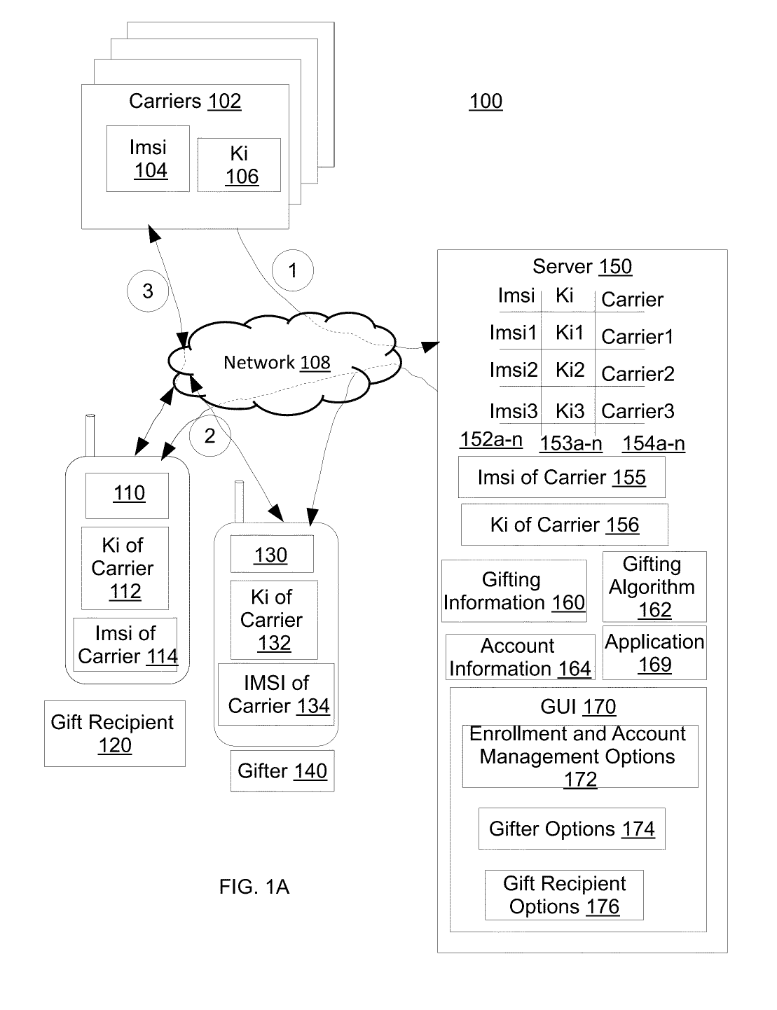

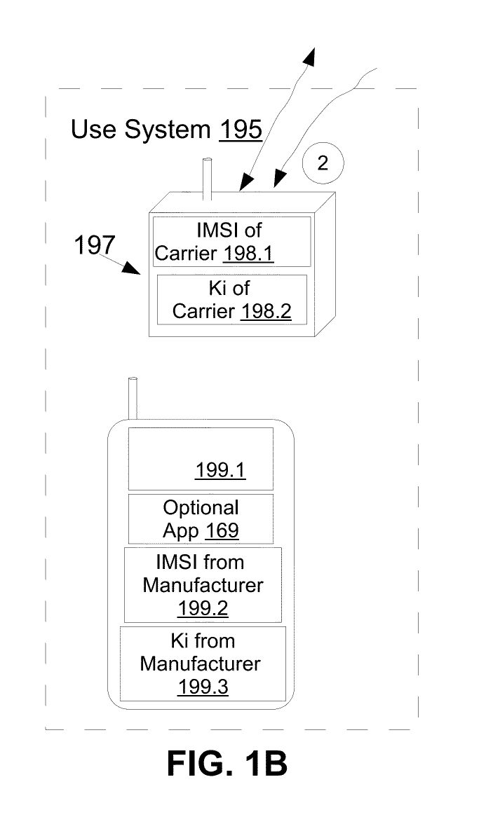

In general, at the beginning of the discussion of each of FIGS. 1-2 and 7-13 is a brief description of each element, which may have no more than the name of each of the elements in the one of FIGS. 1-2 and 7-13 that is being discussed. After the brief description of each element, each element is further discussed in numerical order. In general, each of FIGS. 1-13 is discussed in numerical order and the elements within FIGS. 1-13 are also usually discussed in numerical order to facilitate easily locating the discussion of a particular element. Nonetheless, there is no one location where all of the information of any element of FIGS. 1-13 is necessarily located. Unique information about any particular element or any other aspect of any of FIGS. 1-13 may be found in, or implied by, any part of the specification.

In various places in discussing the drawings a range of letters, such as a-n are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “f”) comes earlier in the alphabet than another letter (e.g., “h”), the order of these letters in the alphabet does not mean that the earlier letter represents a smaller number. The value of the earlier letter is unrelated to the later letter, and may represent a value that is greater the same or less than the later letter.

In this specification, the terms purchaser, consumer, customer, and user are used interchangeably. Each term may be substituted one for another to obtain different embodiments. In an embodiment, a platform is provided for to gift prepaid data plans that the users are not using. Users having a SIM from a primary provider, can choose a specific plan of another carrier and buy the plan using either a smartphone app or website. The prepaid plan users do not always utilize the services, such as the data and/or time purchased completely. In this specification, the term services is generic to and refers to any service that the user may purchase, such as time, data, and/or other services. Instead of leaving this data unused, users are provided with an option to gift the remaining data. In an embodiment, users can choose to gift away all or part of the user's remaining data at that carrier. Once gifted, the users balance is lowered by a specified amount of data and the deducted data is added to a gifting system of the market place provider. In an embodiment, the gifting system decides to whom and how much data is to be gifted.

Any customer of a wireless market place provider can enroll for a data plan gift program to be a gifter or a recipient. The market place provider chooses the recipients based on various criteria. In this specification, the terms market place provider and primary global providers are used interchangeably to refer to the providers that run the marketplace and the associated gifting program. Either term may be substituted one for another to obtain different embodiments. Gift recipients may be given an opportunity to experience the marketplace of wireless services at little or no cost. By gifting the data plan, the recipient may experience the network and value-added services offered by the network, thereby encouraging the user to buy data plans via the wireless service marketplace. The market place provider might choose to split the remaining data gifted from one pan of one user into several prepaid plans and gift each to different users. For example, if 750 MB data of a plan of one user is gifted, the marketplace provider may split the 750 MB into three 250 MB prepaid plans that are gifted to three other users. In an embodiment, the validity of the new gifted plans will be for the same period as that of the originally purchased plan.

The market place provider may assign gift points to a user based on an amount of data gifted. The gift points may be further utilized for a rewards program. The reward program may be in the form of offering discounts in plan prices, extended validity, and/or other services.

In an embodiment, as a consequence of gifting, instead of leaving data unused, an option is available to the user to gift the unused data to fellow users of the gifter's choice.

In an embodiment, for carriers, the gifting program provides an opportunity to promote their network and value-added services without any additional cost. Recipients of the gift program can experience the carrier's network without cost or at a discounted rate, and thereby will be encouraged to buy more plans on the carrier's network. In another embodiment, the gifting program may be used as a charity program for giving phone service to less privileged people, and optionally the privileged users may be offered an opportunity to extend the service for a low price. In an embodiment, a user may be allowed to gift a portion of a plan to a recipient of the user's choice as long as the user gifts another portion of the plan to the market place provider for the market place provider to redistribute.

FIG. 1A shows a block diagram of an embodiment of a system 100. The system 100 may include one or more carriers 102a-n. Each of carriers 102a-n has an IMSI 104 and a Ki 106. The system 100 may include a network 108, a wireless device 110, which includes a Ki of carrier 112 and an IMSI of carrier 114 for a gift recipient 120, a wireless device 130, which includes a Ki of carrier 132 and an IMSI of carrier 134 for a gifter 140. System 100 may also include a server 150, which includes one or more IMSIs 152a-d and Ki's 153a-d, which in turn are associated with one or more carriers 154a-n, an IMSI of the carrier 155, and the Ki of the carrier 156, gifting information 160, a gifting algorithm 162, and account information 164. Server 150 may also include downloadable application 169 and a GUI 170, which includes enrollment and account information 172, gifter options 174, and gift recipient options 176. In other embodiment, the system 100 may not have all of the elements listed and/or may have other elements in addition to or instead of those listed.

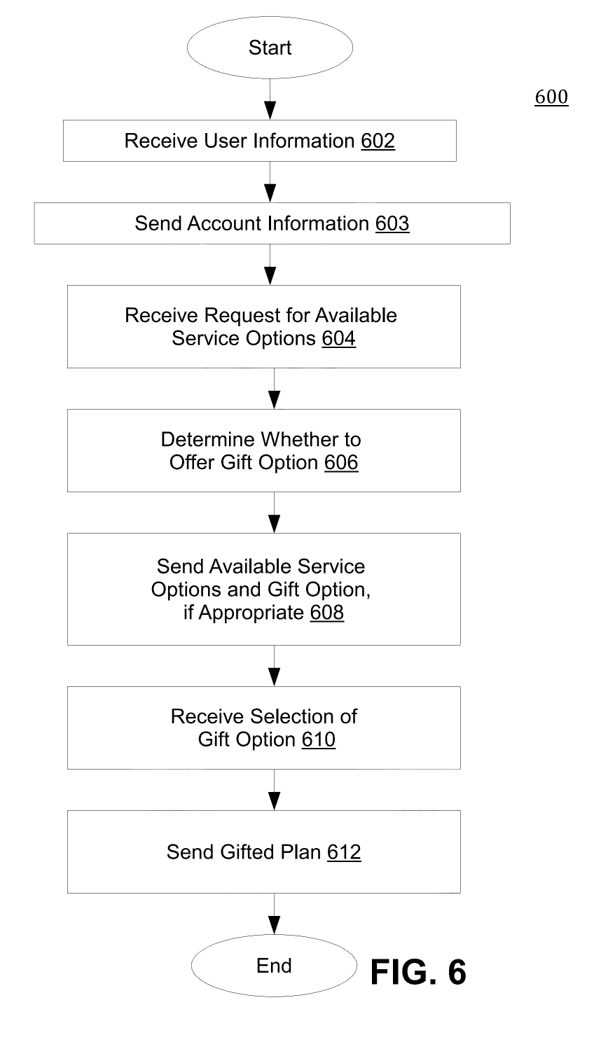

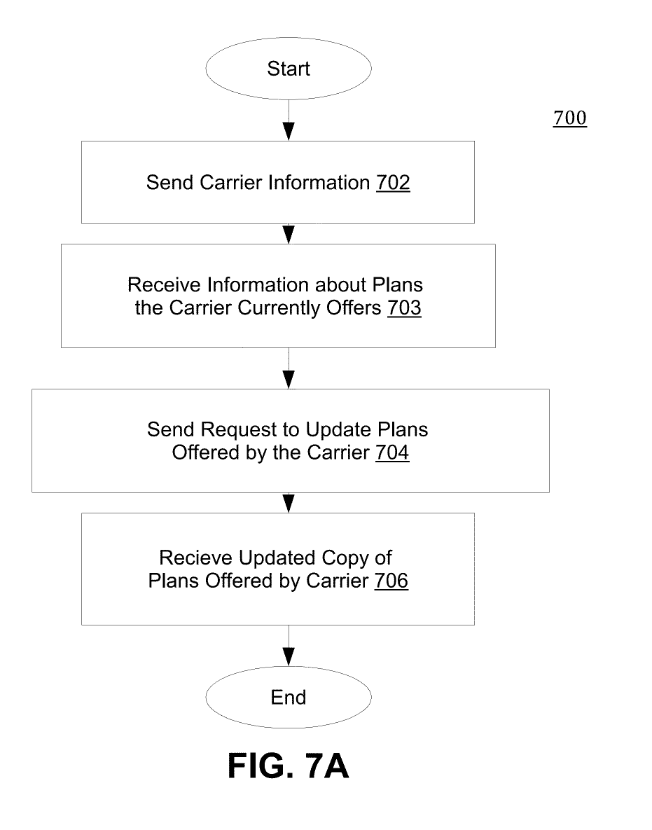

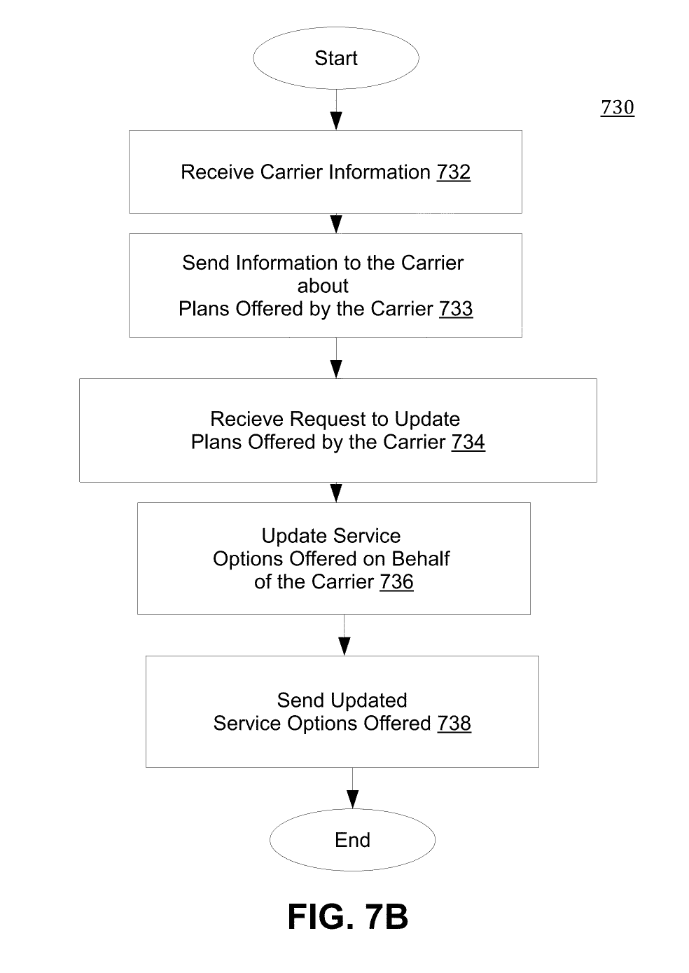

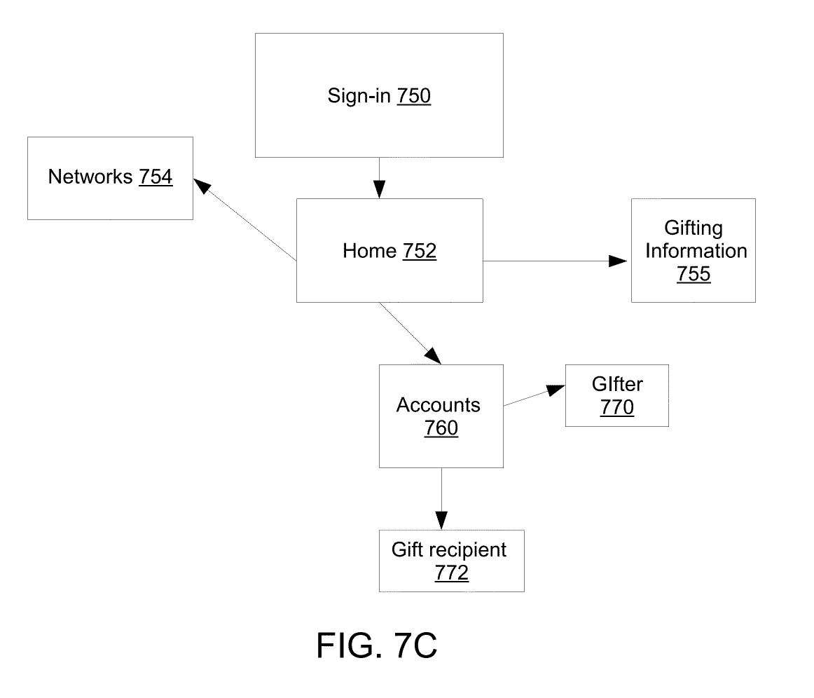

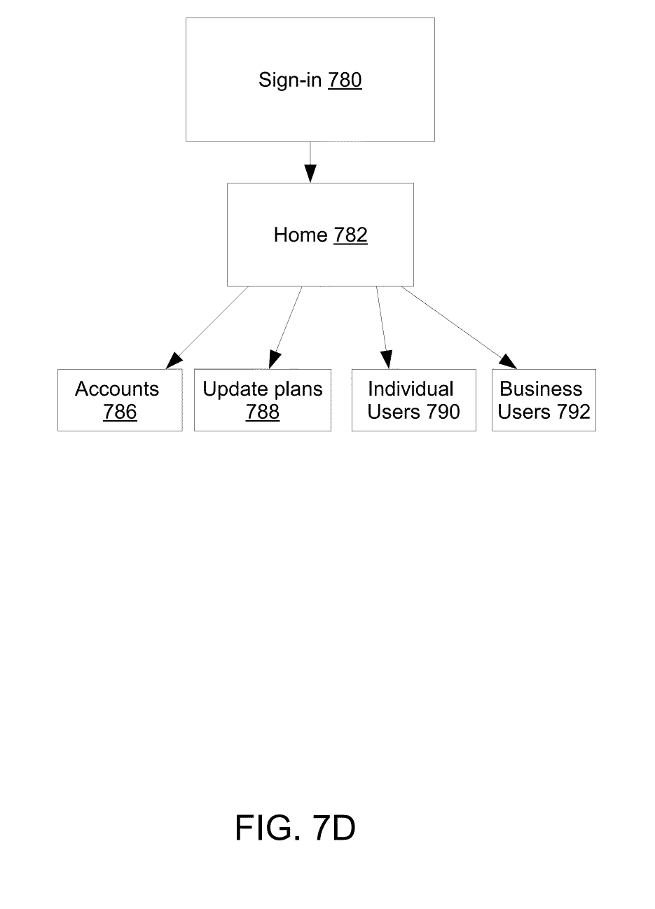

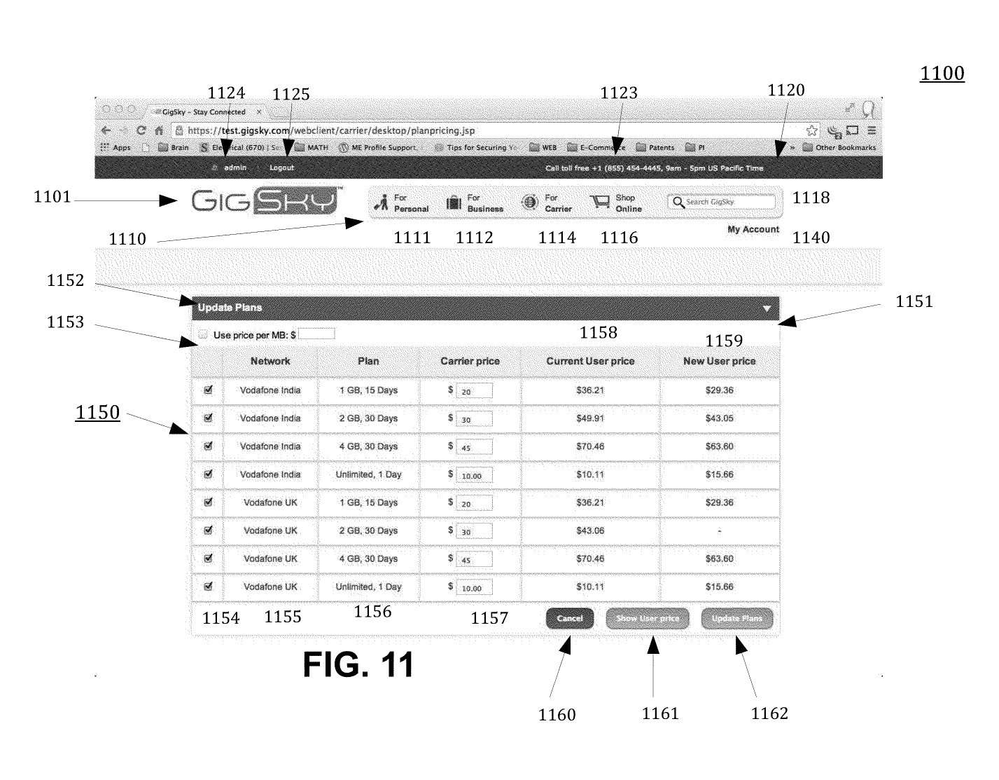

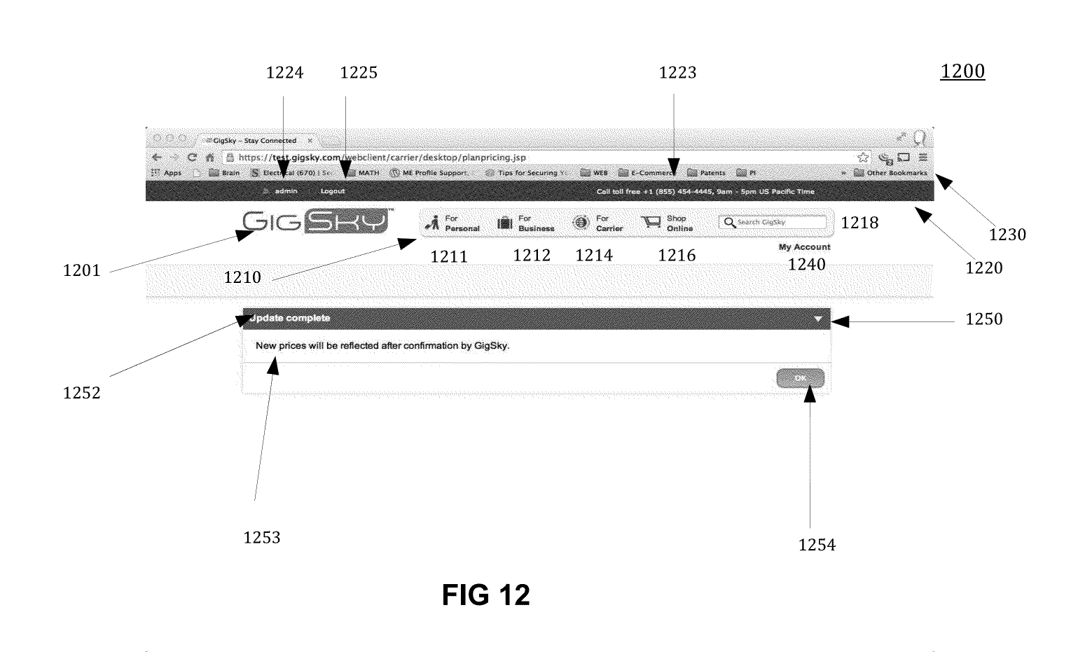

System 100 provides wireless phone service in multiple locations, where each locations is covered by a different set of wireless (e.g., mobile phone) service carrier. The one or more carriers 102a-n are providers of wireless communications services that own or control all the elements necessary to sell and deliver services to an end user, including radio spectrum allocation. A distinction between carriers and other networks is that the carrier owns or controls access to a radio spectrum license from a regulatory or government entity. Carriers require that a wireless device have a manufacturer installed K code, which is an encryption key) that is known only to the mobile network operator, which is the original manufacturer, and is known to the device memory system to allow the wireless device access to the local network. The carrier allows the wireless device to connect and transmit Ks and International Mobile Subscription Identities (IMSIs)s to the wireless device or to the SIM device of wireless device. Examples of carriers will be given later in conjunction with FIG. 6 (AT&T), FIG. 7 (NTT Docomo, SingTel, and T-mobile), and FIGS. 11 and 12 (Vodafone India, Aircel India, Idea, Tata Teleservices, Vodafone, Airtel, Vodafone UK, MTS, Astelit, Kyivstar, and O2).

Each of carriers 102-n has a different International Mobile Subscription Identity (IMSI) 104 and Ki 106 from one another. The IMSI 104 and Ki 106 are used for communication between the carrier and the phone.

The IMSI 104 may include a mobile country code, a mobile network code, and a mobile subscriber identity number. The location area number may describe the location of the wireless device.

The K or Kᵢ 106 may be a 128 bit code that is present on SIM devices (in SIM devices the K or Kᵢ is not changed after the manufacturing or personalization process). The IMSI may be a number used to identify an individual or device on a mobile network. Network 108 is any network or combination of networks of devices that communicate with one another. For example, network 108 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol other protocols may be used instead.

Wireless device 110 is the wireless device of the gift recipient. The wireless device 110 is a portable routing device that is capable of connecting to secure networks that require subscriptions on an ad hoc basis. In another embodiment, wireless device 110 may be any wireless electronic device capable of connecting to a network, such as a phone, personal desktop assistant (“PDA”), laptop computer, tablet, or netbook, for example. The wireless device 110 may communicate with other networks and devices using any wireless protocol including, for example, Wi-Fi, Wi-Max, 2G, 3G, 4G, 4G LTE, UMTS, other satellite communication, or radio via a transceiver. The wireless device 110 may be configured to communicate wirelessly with a local hotspot network, the local mobile server system, the service fulfillment network and/or the networked device.

In one embodiment, the wireless device 110 may have a simulated universal subscriber identity module (“SIM”) stored in the wireless device memory system. Credentials may be electronically transmitted to a SIM. In one embodiment, the wireless device 110 may connect to code division multiple access networks (“CDMA”) and do so using a removable user identity module (“R-UIM”) in substantially the same way as a SIM.

Ki of carrier 112 is the Ki received from the server that is needed to use service of a carrier that was purchased from a server. Wireless device 110 did not have Ki of carrier 112 at the time wireless device 110 was sold by the manufacturer. IMSI of carrier 114 allows the gift recipient 110 to use of the plan bought via the marketplace provider or gifted to the gift recipient. Wireless device 110 did not have IMSI of carrier at 114 the time wireless device 110 was sold by the manufacturer. Gift recipient 120 is the user that receives the gift.

Wireless device 130 (for a gifter) is the wireless device of the gifter. Ki of carrier 132 is a Ki received by wireless device 130 after purchasing service from a carrier that wireless device did not have beforehand. Similarly, IMSI of carrier 134 was received by wireless device 130 after purchasing service provided a carrier that wireless device did not have beforehand, and functions to allow use of the plan by the gift giver (Gifter) 140. Gifter 140 is the user that decides to give away an unused portion of a purchased service. Wireless device 130 functions the same and has been discussed with reference to wireless device 110 of gift recipient 120, above.

Server 150 assists a user to sign up for local service with local carrier even though the user's wireless device was not built by the manufacturer with the IMSI used by a service provider. Server 150 stores the International Mobile Subscription Identities (IMSIs) and Kis of multiple carriers and distributes the IMSIs and Kis to purchasers of services for which the purchaser does not have the IMSI and Ki. When referring to “server” 150, the server 150 may include one or more servers running on one or more machines. Server 150 may run a market place for purchasing wireless services from multiple carriers in multiple locations. Although only one embodiment of the server 150 is shown in FIG. 1A, which includes only one computing device, the server 150 may have any number of servers and/or computing devices. Although in this specification, the word “seller” of the services is often used to refer to the carriers, in an embodiment, the carriers do not actually sell services directly to the user. Instead, in this embodiment, the market place provider may buy the service from the carrier, and then resell the services purchased to the user. Also, in this specification, the term marketplace refers to the market place provider (e.g., GIGsky), which runs server 150.

The one or more IMSI's 152a-d and Ki's 153a-d are associated with one or more carriers 154a-n. The organization running the marketplace will be referred to as the market place provider or primary global provider. The SIM initially may only have the IMSI and Ki needed for communicating with the marketplace provider (any place the IMSI, Ki or SIM “of the server” is referred to, it means the IMSI, Ki, or ISM of the primary global carrier or the market place provider, respectively). The user needs to have the IMSI and Ki for the carrier on the SIM in order to communicate with a given carrier. For example, the market place provider may purchase service form multiple carriers. The user purchases a mobile device having a SIM provided by the marketplace provider, which is the organization running the server 150.

The IMSI of the carrier 155 and the Ki of the carrier 156 are the IMSI and Ki provided by the market place provider, which allows the user to communicate receive service from the carrier.

Gifting information 160 includes the information needed to track the gifting, and ensure that the accounts of all parties participating in the gifting are appropriately adjusted.

The gifting algorithm 162 provides server 150 with the method of facilitating the gifting process. In at least one embodiment, gift points may be assigned to a user based on an amount of data gifted. The algorithm may determine how many gift points are assigned for a given gift, for a given amount of data, for a given time left on plan (days, weeks, months), etc. The gift points may be utilized for a reward program that is implemented by gifting algorithm 162. The reward program may be in the form of offering discounts in plan prices, extended validity, extra bandwidth, and/or other services, depending on the number of gift points. In at least one embodiment, the gifting may be in the form of a simple transfer of the balance of a plan to a recipient, requiring a simple algorithm. The algorithm may implement a different method depending on the carrier and/or the agreement the market place provider has with the other carriers.

The account information 164 includes information related to each carrier's accounts with the market place provider, information related to each user account, the information related to each gifter's account and information related to each gift recipient's account. Account information 164 may also include information for a charity that is involved in the gifting program. The account information 164 can be accessed by the account user (e.g., the carrier, a gifter or a gift recipient), via a page that is password protected or otherwise protected for that account user.

Application 169 is an application that may be downloaded by a user for communicating with server 150. GUI 170 may be a graphical user interface via which a user interacts with server 150 regarding services provided by carriers 102a-n. GUI 170 may include one or more pages related to giving gifts and receiving gifts of unused service. GUI 170 may facilitate access to the gifting system. For example, a user may need to access the system to enroll in the wireless marketplace and/or access an account to gift or receive a gift. A gifter or gift recipient may want to enroll (sign-up), gift, access an account, receive a gift, for example. Enrollment and account management options 172 are pages used by the user to enroll in plans and manage accounts. Gifter options 174 includes one or more pages with which a gifter interacts while gifting unused service of plans that have been purchased, which may offer different options to gifters, such as the amount to gift, to whom to give the gift, options for receiving compensation for gifting. Gift recipient options 176 are one or more pages that the gift recipient interacts with when receiving a gift. Gift recipient options 176 may include different options when receiving a gift. For example, a gift recipient may have an option of different plans to receive.

FIG. 1B shows a block diagram of an example of wireless system 195. Wireless system 195 may include application 159, potable router 197, Ki of carrier 198.1, IMSI of carrier 198.2, mobile device 199.1, IMSI from manufacturer 199.2, and Ki from manufacturer 199.3. In other embodiment, the system 100 may not have all of the elements listed and/or may have other elements in addition to or instead of those listed.

Application 159 was described in FIG. 1A. However, in FIG. 1B application 159 has been downloaded and stored in the user system, which the user may use as a user interface to communicate with server 150.

Wireless system 195 may be an embodiment of wireless system 110 or 130. Portable router 197 includes a programmable SIM, which is capable of having an IMSI and Ki of a local carriers written to the programmable SIM, so that each time (if so desired) when the user changes locations, a new local carrier may be selected by downloading, via server 150, a new IMSI and Ki of another carrier. Ki of primary carrier 198.1, and IMSI of primary carrier 198.2 are embodiments of Ki of carrier 112 and IMSI of carrier 114, which were described in conjunction with FIG. 1A. Mobile device 199.1 communicates with portable router 197, which in turn communicates with one of local carrier 102a-n and/or server 150. Mobile device 199.1 may be a mobile phone or another mobile device, for example. Alternatively, mobile device 199.1 may communicate, via portable router 197, using a portion of GUI 170 that has end-user pages to communicate with sever 150.

Other embodiments are discussed in AZ-3, AZ-4, AZ-6, and AZ-7, each of which is incorporated by reference in its entirety, United States patent application Number (Docket #AZ-9) entitled “GLOBAL e-MARKETPLACE FOR MOBILE SERVICES,” filed Feb. 1, 2014, U.S. Provisional Patent Application No. 61/759,691 (Docket # AZ-7), entitled “GLOBAL e-MARKETPLACE FOR MOBILE SERVICES,” filed Feb. 1, 2013, by Ravi Rishy-Maharag et al., which are incorporated herein by reference in its entirety.

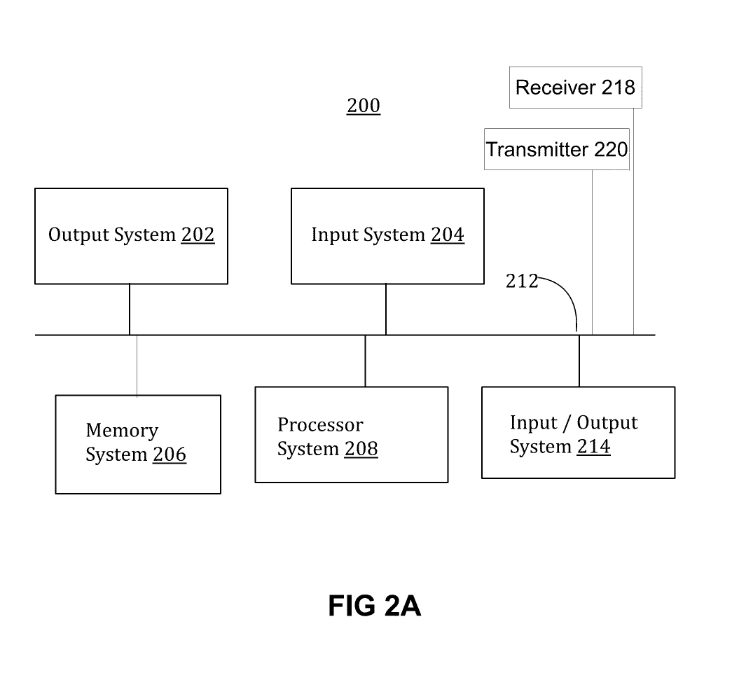

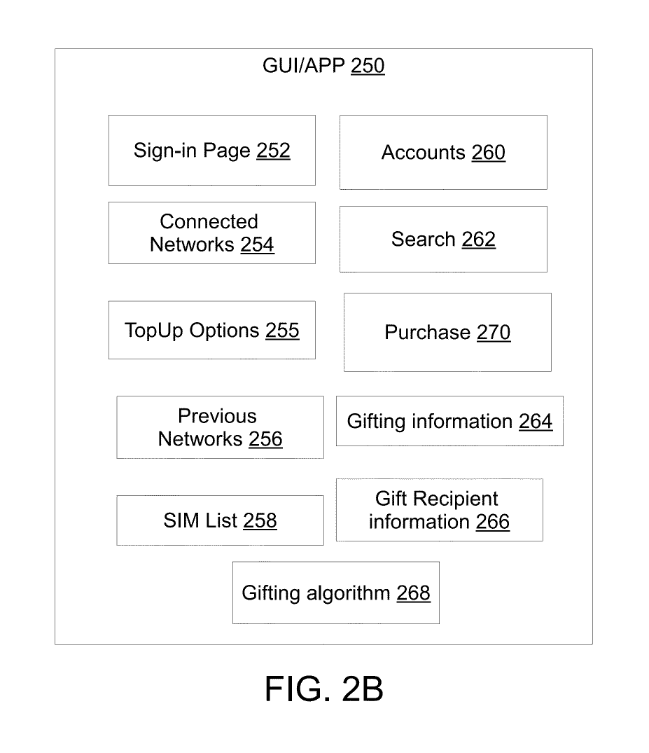

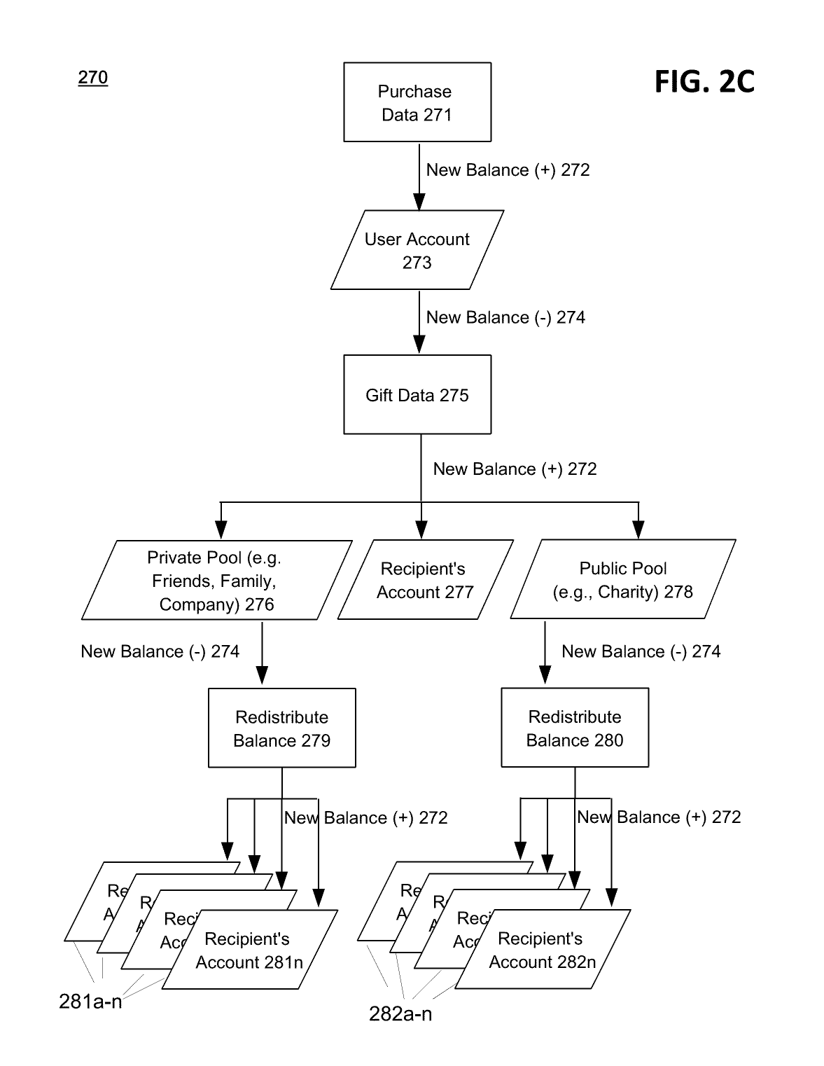

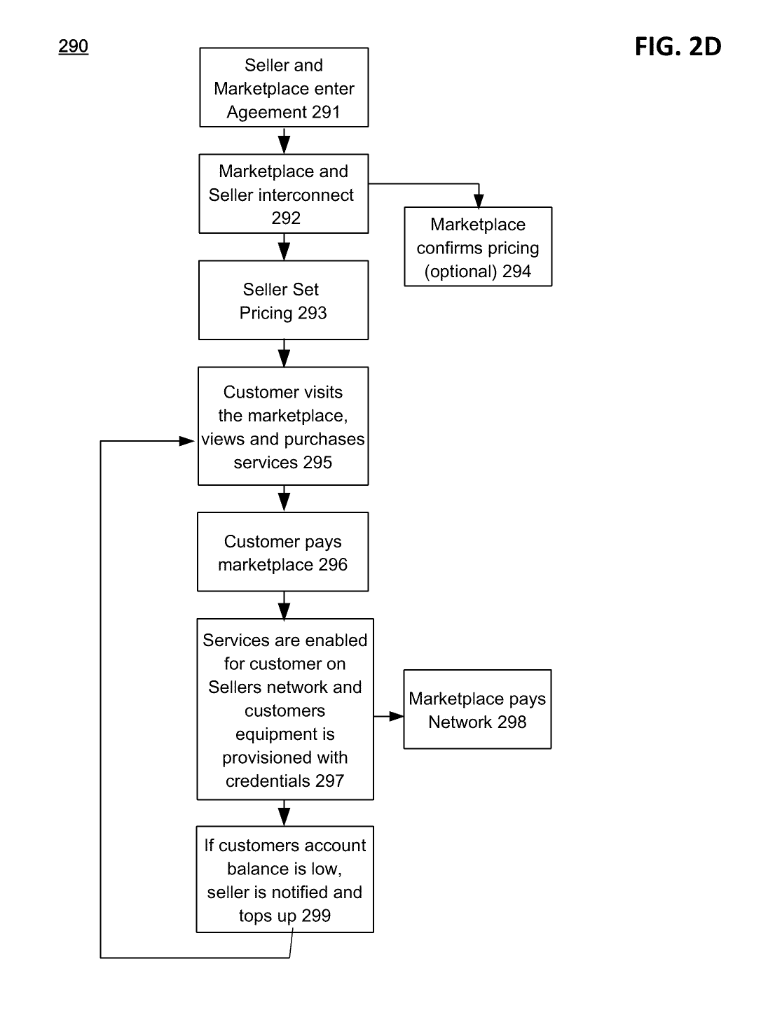

FIG. 2A shows a block diagram of a machine 200 having wireless capabilities. The machine 200 may include output system 202, input system 204, memory system 206, processor system 208, communications system 212, input/output device 214, receiver 218, and transmitter 220. In other embodiments, machine 200 may include additional components and/or may not include all of the components listed above.

Machine 200 is an example of a computer that may be used for server 150 of FIG. 1A. Machine 200 may also represent the mobile device 110, 130, 197, or 199.1 of the user or a machine of one of the local carriers.

Output system 202 may include any one of, some of, any combination of, or all of a monitor system, a handheld display system, a printer system, a speaker system, a connection or interface system to a sound system, an interface system to peripheral devices, a wireless transmitter and/or a connection and/or interface system to a computer system, intranet, and/or internet, for example.

Input system 204 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, a wireless receiver and/or internet (e.g., IrDA, USB), for example.

Memory system 206 may include, for example, any one of, some of, any combination of, or all of a long term storage system, such as a hard drive; a short term storage system, such as random access memory; a removable storage system, such as a floppy drive or a removable drive; and/or flash memory. Memory system 206 may include one or more machine-readable mediums that may store a variety of different types of information. The term machine-readable medium is used to refer to any non-transitory medium capable carrying information that is readable by a machine. One example of a machine-readable medium is a non-transitory computer-readable medium. Another example of a machine-readable medium is paper having holes that are detected that trigger different mechanical, electrical, and/or logic responses.

If machine 200 is the user's mobile device, then memory system 206 may store the IMSI and Ki of the carrier, which were received via server 150 as a result of purchasing the carrier's service at the marketplace that is run on the server 150. Memory system 206 may include a decryption algorithm for decrypting the IMSI sent by the server with Ki of the server. Memory system 206 may also store an application for sending a request from the user's machine for service, requesting a list of carriers, a local carrier, receiving the list from the server, sending a selection of a carrier, receiving the IMSI and Ki of the selected carrier, send a request to purchase new service or purchase a modification to service already in place, send a request to gift service to another user, and display the crediting the user account, for example.

If machine 200 is the server, then memory system 206 may store a collection of IMSIs and Kis from a variety of carriers to send to the users that purchase service, via server 150, but do not have the IMSI and Ki for the carrier providing the service purchased. Memory 206 may include an encryption algorithm for encrypting the IMSI with the Ki of the server to send the encrypted IMSI to the user's mobile device. Memory system 206 may also store an algorithm for sending a request from the user's machine for service, sending a list of local carriers to the user, receiving a selection of a carrier, purchasing service of the selected carrier, and receiving the IMSI and Ki of the selected carrier, for example. Memory 206 may store pages that offer the user the opportunity to gift unused services. Memory 206 may store pages for offering the unused services to other users. Memory 206 may store an algorithm for accepting the gifted services, offering the gifted service to other users and/or for determining, which users to offer the gifted services (which may be based on a user selection or other criteria).

Processor system 208 may include any one of, some of, any combination of, or all of multiple parallel processors, a single processor, a system of processors having one or more central processors and/or one or more specialized processors dedicated to specific tasks. Processor system 208 implements the machine instructions, methods, and/or processes stored in memory system 206.

Communications system 212 communicatively links output system 202, input system 204, memory system 206, processor system 208, and/or input/output system 214 to each other. Communications system 212 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 214 may include devices that have the dual function as input and output devices. For example, input/output system 214 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 214 is optional, and may be used in addition to or in place of output system 202 and/or input device 204.

Receiver 218 and transmitter 220 receive and transmit, respectively, wireless signals. Receiver 218 and transmitter 220 may be part of output system 202, input system 204, and/or input/output system 216. Receiver 218 and transmitter 220 may be replaced with a transceiver.

FIG. 2B shows a block diagram of functions 250 carried out by the machine having wireless capabilities. The functions (GUI/APP) 250 may include sign-in page 252, connected networks 254, top up options 255, previous networks 256, SIM list 258, accounts 260, search 262, gifting information 264, gift recipient information 266, gifting algorithm 268, and purchases 270. In other embodiments, machine 200 may include additional components and/or may not include all of the components listed above.

The sign-in page 252 may e used by a user to sign into the market place on server 150. The sign-in page 252 may include fields for signing in, such as a field for entering a user name (which in an embodiment may be the user's e-mail address) and a field for entering a password. The password and user name password may be sent to server 150 for authentication. The sign-in page 252 may also include hints about the username and/or password. The sign-in page 252 may also include a link that may be activated if the user does not remember the username or password. In an embodiment, the same sign-in page is used for consumers and carriers. In another embodiment, there may be one sign-in page for users accessing phone services and another sign-in page for carriers modifying the plans that are being offered to the user of the phone services. In one embodiment, the sign-in page for mobile phone users is part of a downloadable application that is down loaded to the mobile phone user's phone, while the sign-in page for the carrier is part GUI 170 (FIG. 1A) or an application that is downloaded by the carrier for managing the suite of services that the carriers offer.

Connected networks 254 identifies and presents to the user a list of the networks of the carriers that the user is connected to.

Top up options 255 provides account balances, and offers the option to the user to add more time, data and/or other services to the accounts. Top up options 255 may provide the user with a list of the accounts, and a list of top-up options (to top up an account is to add more service, such as more time or more data to the account). Top up options 255 may indicate to the user that the selected top up option is the amount of service that will be added to the account selected by the user.

Previous networks 256 identifies which networks the user was previously connected to and provides the list of networks to the user (e.g., in a list form). The previous networks may also include information about with locations covered by the previous networks, pricing, plans, time, dates, and/or other information.

SIM list 258 identifies which SIMs the user already owns or has installed, and provides the SIMs that are owned by the user as a list to the user.

Accounts 260 identifies which accounts the user currently has (with which networks and carriers) and/or had in the past and provides the user with a list of the accounts. The information provided by accounts 260 may also include dates that service is available for an account, prices of the services available for the account, plans in the account, locations at which service was available, and/or other information related to the accounts.

Search 262 functions to allow the user to perform searches for wireless service providers. After finding a wireless service provider, via search 262, the user may be presented with an link that initiates a purchase of one of the services found.

Gifting information 264 is an embodiment of gifting information 160, which was discussed in conjunction with FIG. 1A.

Gift recipient information 266 is an embodiment of gift recipient information 176, which was discussed in conjunction with FIG. 1A.

Gifting algorithm 268 is an embodiment of gifting algorithm 162, which was discussed in FIG. 1A.

Purchases 270 functions to identify and carry out any purchases the user selects and keeps a record of past purchases. Purchases 270 may provide the user with fields for entering the amount of the purchase, entering payment information, and confirming the purchase.

FIG. 2C shows a flowchart of an embodiment of a method 270 for gifting. In method 270, a user gives away unused services that were already purchased, so that others may use the services given away. The user that purchased the services being gifted may be leaving the service area in which the unused services are usable and would prefer that someone else benefit from the unused services, than seeing the unused service expire without ever being used.

In step 271, if the user has an account on server 150, the user purchases service (e.g., minutes of service and/or an amount of data that may sent), resulting in a New Balance (+) 272. If the user does not have an account on server 150, the user first sets up an account and then purchases service. For example, the user may own a mobile phone, and have service with ATT in San Jose, Calif. The user travels to India for a 4 days, and purchases service for 15 days with Vodafone India.

In step 273, as a result of step 271, the user has an account on server 150, which allows the user to use services on one of carriers 102a-n, and uses part of the balance resulting in a New Balance (−) 274. Optionally, the account may have settings that relate to gifting choices, such as whether to gift unused portions to family and friends, to a charity and/or whether to gift service to server 150 in exchange for a promotional offer, such as discounted rates on future services and/or other free or discounted services.

In step 275, the data is gifted (by the user or the system) resulting in a New Balance (+) 272. The user may have signed up for the gifting system, and indicated how gifted services should be gifted. In an alternative embodiment, instead of the user manually gifting services each time the user wants to gift service, the user may select to settings for when balances are automatically gifted. For example, in this alternative embodiment, the user may select to gift certain services, when the user leaves a particular geographic location. Returning the example, the example of step 271, the user realize that since the user will be in India only for 4 days, the user has purchased 11 days worth of services from Vodafone India, that the user cannot use, and consequently the user decides to gift 11 days worth service from the plan that was just purchased. Perhaps the user purchases the service from Vodafone India prior to leaving for India and even decides to gift the amount of service purchased that the user does not expect to use prior to leaving for India.

In step 275, a recipient is chosen for the gift. There are three choices, which are in steps 276, 277, and 278.

In step 276, the gift data can be gifted to a private pool. The private pool may be chosen by the user and may include friends, family, and coworkers. The private pool may also include one or more charities. As a result, the account of the gifter (New balance (−) 274) is updated. If there is any balance left, depending on the circumstance, the user or the system can decide where to gift the balance. In at least one embodiment, if there is any question, the default may be to gift any remaining to the public pool. Optionally, there may be tools for setting up a list of friends and family, in which the user may enter whomever the user desires. Then when gifting, the user may just select the appropriate person from the list. Returning to the above example, perhaps the user visiting India has family in India, and a friends or coworkers that do a lot of traveling. The user may add the friends, coworkers and family to a friends and family list. Then the user gifts the 11 days worth of service to a pool of friends and family in the user's friends and family list. After step 276, the method proceeds to step 279 and then to 281a-n, which will be discussed below.

Alternatively, in step 277, the gift data can be gifted to a recipient's account. The user may specify exactly which recipient and/or which account the service is gifted to. For example, in an embodiment, the user may specify a specific family member or coworker that the user knows will be in India during the period in which the remaining 11 days of the plan purchased, and so the user enters the user name or email address (and optionally other identifying information) of the intended recipient and gifts the 11 days worth of service. Alternatively, in and embodiment, the user selects the intended recipient from the friends and family list, and gifts the remaining 11 day to the selected recipient rather than gifting the remaining 11 days to the family and friends pool. In an embodiment, the recipient may also be a charitable organization or other organization.

Alternatively, in step 278, the gift data can be gifted to a public pool. The public pool may include one or more charities, one or more people with low income who sign up for a charity account, one or more developing countries as part of a charity account, etc. In an embodiment, if the user does not choose the recipient, there is a default recipient, which may be a public pool or the private pool, for example. As a result, the account of the gifter (New balance (−) 274) is updated. After step 278, the method proceeds to step 2280 and then to 282a-n, which will be discussed below.

Returning to step 276, if the balance is gifted to a private pool (in step 276), in step 279, the amount gifted (New Balance (+) 274) is redistributed into one or more recipient's accounts 281a-n. For example, the amount gifted may be available to all of the pool members, and whomever in the pool elects to use the gifted services first receives the gifted services.

Returning to step 278, if the balance is gifted to a public pool (in step 278), in step 280, the balance (in new balance (+) 272) is redistributed into one or more recipient's accounts 282n. In step 278, server 150 may optionally determine which charities in the pool cannot use the amount gifted, because those charities are in locations that cannot use the amount gifted, and server 150 may offer the amount gifted to the remaining charities or to all of the charities in the pool, and the first to accept the service receives the service. Alternatively, in steps 276 and 278, the unused data purchased may be evenly divided among the pool members or may be divided according to a user-determined distribution.

In an embodiment, each of the steps of method 270 is a distinct step. In another embodiment, although depicted as distinct steps in FIG. 2C, step 271-282n may not be distinct steps. In other embodiments, method 270 may not have all of the above steps and/or may have other steps in addition to or instead of those listed above. The steps of method 270 may be performed in another order. Subsets of the steps listed above as part of method 270 may be used to form their own method.

FIG. 2D shows a flowchart of an embodiment of a method 290 for implementing a marketplace for wireless service.

In step 291 the seller/carrier and marketplace provider/primary global carrier enter into an agreement. The agreement may be for the carrier to be involved in the market place provider's service for providing prepaid data plans, for providing global service/plans, for gifting, etc. The agreement may involve the carrier issuing a set of IMSIs and Ki's that may be sent by the market place provider to a user that purchases service. The carrier may also be involved in a variety of ways. For example, the carrier may buy advertisement time, the carrier may pay to be listed when a user searches for a carrier in a specific location, optionally the carrier may pay to be involved in the gifting program, etc. The market place provider may purchase services from the carrier (e.g., in the form of quantities of data that may be transferred), which may be resold to the user. Alternatively, or additionally, the carrier may pay to offer for sale on the marketplace (running on server 150) any one of, or all of, the services the marketplace/market place provider provides. In yet another embodiment, after a service is sold, the carrier receives a portion of the payment and the market place provider receives another portion of the payment. The agreement may result in the carrier being enrolled in the service, at which time the carrier receives an account with the service/marketplace, so that plans of the carrier being offered in the marketplace.

In step 292, the marketplace and the carrier (or seller) interconnect. Connecting the carrier and the marketplace provider may involve adding the carrier t to the database and giving the carrier the ability to set up plans and/or to edit plans that are available for the user to purchase.

In step 293, the carrier sets the pricing. The carrier can decide on the pricing for one or more plans, for service in one or more locations, and optionally may decide on gifting options available to the user. In an embodiment, the carrier sets the price that the carrier is compensated for the purchase of a service, whereas the marketplace provider set the price offered to the consumer. Alternatively, the carrier sets the price that the service is offered to the user (and the compensation to the market place provider may be determined based on the agreement in step 291 and a predetermined algorithm that computes the market place providers compensation).

In step 294, optionally, the marketplace confirms the pricing. In at least one embodiment, the marketplace may want to have a say in one or more aspects of the pricing. For example, the marketplace may have a particular algorithm that is used for deciding aspects of gifting. In this case, the carrier may have to adhere to the algorithm when deciding on pricing options. For example, the carrier may only set the price that the marketplace provider needs to pay the carrier, but the marketplace provider may decide on the final price for the service that is offered to the user.

In step 295, the customer visits the carrier's network, and the customer views and purchases services. The customer can be any user, gifter, and/or gift receiver. The customer can visit the network GUI and can decide on a plan, location, gifting option, etc. that the customer wants to purchase. The customer can view a list of carriers and decide which carrier and/or plan the customer would like to purchase.

In step 296, the customer pays the marketplace provider, via a user interface (e.g., via GUI 170 or application 169). The customer sets up an account and/or pays the marketplace provider using any of a variety of methods. For example, the customer may pay via credit card. Alternatively, the customer may choose to be billed monthly for the service. Optionally, the customer may buy minutes, time, data, etc. for a short time period, such as, while the customer is in a particular location. In an embodiment, the carrier may only be listed in the marketplace on server 150 when the carrier has an agreement with the marketplace provider. In other words, when the customer does a search on server 150 for carriers in a particular location, if the carrier does not have an agreement with the marketplace provider, the carrier will not be listed in the marketplace.

In step 297, the services are enabled for the customer on the seller's network and the customer's equipment is provisioned with credentials. The method may involve server 150 sending an IMSI and Ki of the service being purchased, but encrypted with a Ki of another service, that the user already has. For example, if the user has service with ATT and is purchasing service from India Votaphone, the user has ATT's Ki and IMSI but does not have India Votaphone's Ki and IMSI. So, server 150 sends the India Votaphone's IMSI and Ki, but in an embodiment, encrypts India Votaphone's IMSI and Ki with ATT's Ki (since the purchaser already has ATT's Ki).

In step 298, the marketplace provider pays the carriers 102a-n. As part of the agreement, the marketplace may agree to pay the network/carrier a certain amount depending upon the number of customers the carrier obtains.

In step 299, if the customer's account balance is low, the seller is notified and tops up. Steps 295-299 are repeated. Step 293 may also be repeated independently of repeating steps 295-299. The customer buys a specific plan, number of minutes, MB, etc. Thus, when the balance of the minutes is low or the plan is close to the end date, the seller can be notified. The marketplace (global primary carrier) identifies which accounts the user may add more time, etc. to, provides the user with a list of the accounts, and indicates to the user that the selections in the list are amounts by which the user may top-up (add more time or more of another consumable service) to the users account.

In an embodiment, each of the steps of method 290 is a distinct step. In another embodiment, although depicted as distinct steps in FIG. 2D, step 291-299 may not be distinct steps. In other embodiments, method 290 may not have all of the above steps and/or may have other steps in addition to or instead of those listed above. The steps of method 290 may be performed in another order. Subsets of the steps listed above as part of method 290 may be used to form their own method.

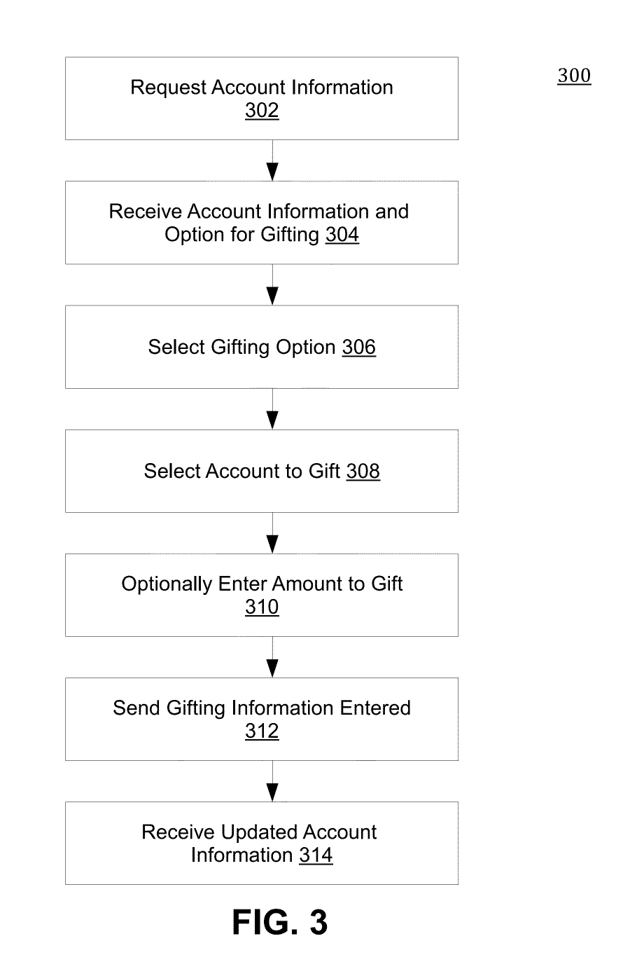

FIGS. 3-6 provide flowcharts are examples of methods of gifting that may be implemented using the system 100.

FIG. 3 shows a flowchart of an embodiment of method 300 for gifting unused services from the point of view of the user, via a wireless phone service that is available in multiple locations in which that are not all covered by the same phone service. In FIG. 3, the user is the gifter.

In step 302, the user or gifter requests account information. The account information may be any account information discussed herein, which may include account balances. In at least one embodiment, the user requests information related to the balance of a plan the user has with a specific carrier. The user may also be requesting information specifically about the user's gifting account—the gift points, the rewards, and/or may just request information about accounts to determine, which accounts have unused services that the user would like to gift (e.g., because the user does not expect to use those services). For example, the user may have purchased phone service for 30 days in India, but the user only expects to be in India for the first 15 of those 30 days.

In step 304, the user receives account information and an option for gifting. The option for gifting, may include information specific to the user's balance for current accounts (showing services that were purchased but not used yet), gift points, rewards, etc. for a given carrier's plan. In an embodiment, the option for gifting may vary depending on the carrier, the plan, and or the location. In step 306, the user selects a gifting option. The one or more pages related to the option for gifting may include specific choices for the user to select and/or fields that the user can enter the user's choice of a gifting option.

In step 308, the user selects an account to gift. In an embodiment, the user may gift the unused services without specifying anything about whom the recipient should be. In an embodiment, the user may select to receive a promotional offer or choose from a list of promotional offers that the user would like to receive in exchange for the gifted service. In an embodiment, the user may select an account from a list of accounts shown to the user, from a list of charities, a list of less privileged users, from a list of charity accounts, or the user may indicate by typing into a field the account the user wants to gift to. For example, the user may want to gift to a family member or friend. In at least one embodiment, the user can gift to a specific charity. In at least one embodiment, the user can gift to a person on a list of charitable gifts. In this embodiment, a gift receiver might enroll in the gifting system to receive a charitable gift. For example, a user from a developing country may enroll. In an embodiment, the user may select whether to gift the unused service to a family or friend, receive a promotional offer in exchange for gifting the unused service, and/or to give the unused service to a charitable cause.

In step 310, the user optionally enters an amount to gift. The user/gifter may indicate in a field how much of the user's balance the user wants to gift to a specific recipient. In an alternative embodiment, the user may convert the services gifted into reward points or gift points, and may then also gift the reward points instead of using the gift points or reward points. In at least one embodiment, the user may only choose one recipient for the remaining balance of unused services of a particular account. In another embodiment, the user may select how much of the remaining balance to gift and gift different portions of the remaining balance to different recipients, purposes, and/or causes. For example, part of the remaining balance may go to a friend, part to a first charity, part for use by those in an underdeveloped country, and part in exchange for a promotional offer.

In step 312, the user sends gifting information entered. The user may indicate when the use has finished entering the gifting information by activating an enter or submit button. The user may then be provided with a summary of the user's gifting choices to confirm the user's gifting choices.

In step 314, the user receives updated account information. Once the gift is chosen and sent by the user, the user may get a confirmation message and/or updated account information.

In an embodiment, each of the steps of method 300 is a distinct step. In another embodiment, although depicted as distinct steps in FIG. 3, step 302-314 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

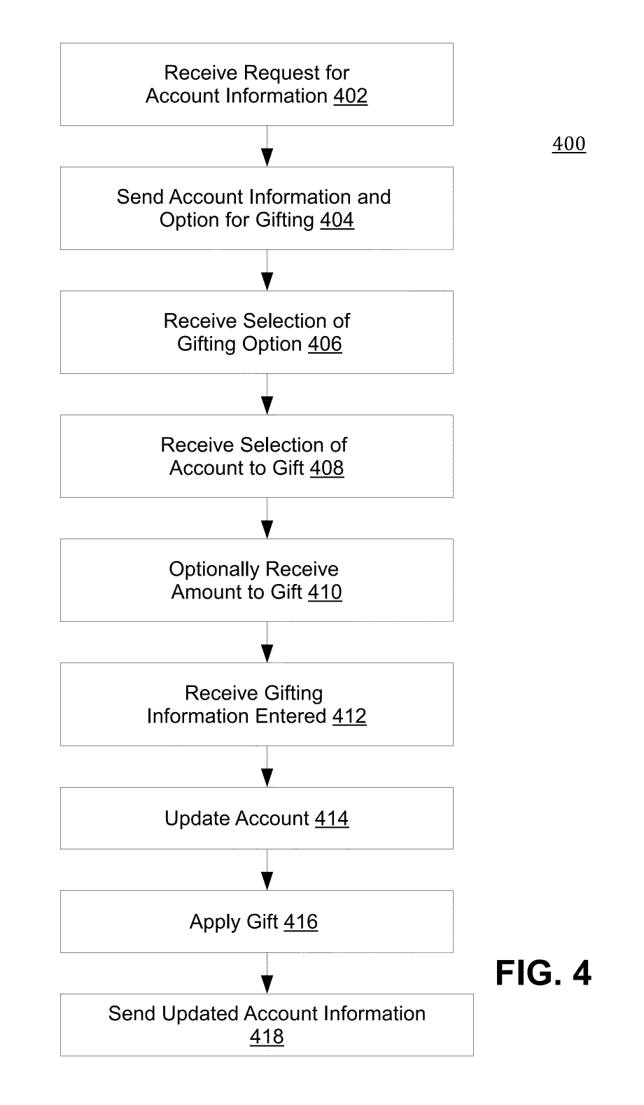

FIG. 4 shows a flowchart of an embodiment of method 400 for gifting unused services from the point of view of the server, via a wireless phone service in multiple locations that are not all covered by the same phone service.

In step 402, the server receives a request for account information from the user. The request may be sent via a GUI specific to the server 150, which is run by the market place provider. In an embodiment, the server may only receive requests from a user that has enrolled in the service.

In step 404, the server sends account information and information causing the user system to display an option for gifting. The server may then identify the carrier or carrier's with which the user has purchased service, the balance for each plan and/or carrier (e.g., the number of minutes the user has in the plan for that carrier). In an embodiment, the same gifting options are available regardless of the carrier providing the service being gifted. In another embodiment, different gifting options are available for different carriers. Optionally, if gifting options are allowed for different carriers, the server may also identify the gifting options for that carrier. The server may also identify and send the user's gifting account information.

In step 406, the server receives the selection of the gifting option from the user. The selection of the gifting option results in the server transferring the gifted balance to another account and/or to a pool of gifted accounts. Then the server may send information about which services the user chose to gift to the gift recipients. If the service was gifted to a pool of users, the services gifted may be distributed by the server and/or may be selected by other users that the server allows to distribute and/or receive the gift. For example, the gifted remaining services may appear in a list of service options available to a pool of users that another user from the pool may select to add to that user's account own account, thereby receiving only the gifted service that was selected and not receiving the other gifted services that were offered, but not selected.

In step 408, the server receives a selection of the account to gift. The account to gift belongs to a gift recipient. The gift recipient may be a person the user knows (e.g., family member, friend), a charitable organization, a specific person identified as part of a charitable group, an account that stores gifted services for later distribution to other users a promotional offers to try the service, and/or another account.

In step 410, the server optionally receives an amount to gift. The amount gifted may be specifically chosen by the user, or the amount may be specified in the gifting option and/or by the carrier or carrier plan. In an embodiment, the user may be able to choose to gift the remaining balance left of a service, whatever the remaining balance is.

In step 412, the server receives gifting information entered. The server may allow the user to review the choices the user has made and to enter the information. After the information is entered, the server may finish the gifting process.

In step 414, the server updates the account to finish the gifting process. Updating the account may involve subtracting the gift from the user's plan, and optionally adding gift points and/or other rewards to an account of rewards or gift points of the user giving the gift.

In step 416, the server applies the gift. The server may then take the gift received from the user's account and apply gift to the gift the recipient's account, add the gift to a pool of gifts available to pool of people and/or organizations, store the gift for later distribution, and/or offer the gift to another user as one of many other selections of service, for example.

In step 418, the server sends the updated account information to the user. The server may also send a notification of the gift and updated account information to the recipient.

In an embodiment, each of the steps of method 400 is a distinct step. In another embodiment, although depicted as distinct steps in FIG. 4, step 402-418 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

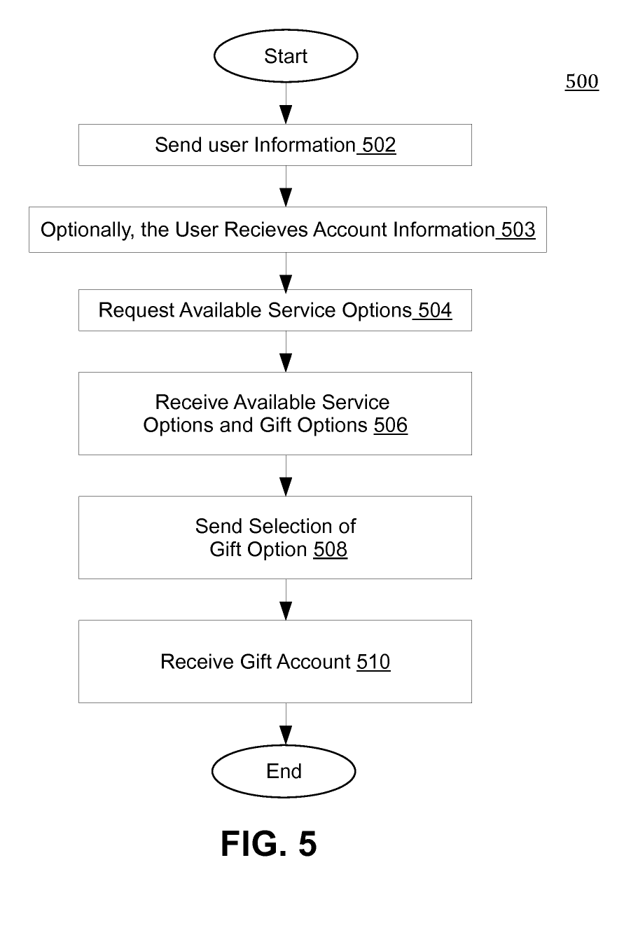

FIG. 5A shows a flowchart of an embodiment of method 500 for receiving a service gifted by another user from the point of view of the user, in a system for providing wireless phone service in multiple locations that are not all covered by the same phone service. The user in FIG. 5 is the gift recipient.

In step 502, the user/gift recipient sends user information. In an embodiment, the gift recipient needs to sign into the system of the market place provider (e.g., via server 150), thereby providing the user information. The gift recipient may need to enroll in the marketplace provider's system, if the user is not already enrolled, and the information provided during enrollment may then be used each time the user signs in to provide information and service options appropriate for the user. Optionally the user information may be sent as part of a request for account information.

In step 503, optionally the user/gift recipient receives account information or information with when consumed by the user system causes the user system to display a page for requesting service options. The user may receive information confirming that the sign-in was successful and/or may receive a page showing that the user has unusable balances on one or more accounts.

In step 504, the user requests available service options. The gift recipient may specify a location for which service is desired and/or also optionally a carrier that covers a location of interest to the gift recipient as part of the request. The available service options may include which carriers are involved in the gifting service, which plans are available from the carrier, what types of gifting the user/gift recipient qualifies for, etc.

In step 506, the user receives available service options and gift receiving options. The gift receiving option may involve how much service is available, such as how much time and/or data the gift recipient will receive if that particular option is selected. The user may be able to select to receive one or more of several gifts that are available to the user to receive. The available service options may include a specific gift that is sent to the user from a gifter. The specific gift may be sent in one form, with the option by the gift recipient to choose another form. For example, the gift may be sent as gift points and the gift recipient may be able to use the gift points to choose a specific plan with a specific carrier that the gift recipient chooses.

In step 508, the user sends a selection of one or more gift receiving options. The user/gift recipient has thereby selected a gift to receive. The option selected may come with an option to purchase more service for the same plan when the gift is finished.

In step 510, the user receives an account. The gift is then applied to the user/gift receivers account. When the gift is close to being used up or close to ending, the server may send the gift recipient a message with information about how the gift recipient can purchase a plan and/or a discounted plan.

In an embodiment, each of the steps of method 500 is a distinct step. In another embodiment, although depicted as distinct steps in FIG. 5, step 502-510 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

FIG. 6 shows a flowchart of an embodiment of method 600 for allocating a service gifted by another user from the point of view of the server, which is part of a system for providing wireless phone service in multiple locations that are not all covered by the same phone service.

In step 602, the server receives the user information. The user may send the information as part of enrolling and/or signing in to the system.

In step 603, the server sends account information to the user, which may include plans that have unused service.

In step 604, the server receives a request for available service options from the user system. Available service options may include prices, plans, etc. that the user may choose. The available options may also include an option for gifting unused portions of services purchased.

In step 606, the server determines whether to offer a gift option. The server may determine whether another user sent a gift to the user as one of the user's friends or family. The server may determine whether the user is eligible for a gift based on the user's location, based on the user being part of a charitable organization, based on the user being part of a particular type of charitable organization, based on the user being part of a particular pool, such as a member of a pool of friends and family. The server may determine to offer services that were gifted by others as a promotion.

In step 608, the server sends available service options and gift options if appropriate, to the user. The user can then review the list of service and gift options for one that fits the user's needs/wants. For example, the server or carrier may want to provide a certain number of gifts or a certain amount of time to interest new users. Then the server may give preference to first time users or user that do not yet have an account to be gift recipients, to allow the gift recipients to experience the services provided by the market place provider. By being a gift recipient of a data plan, the recipient may experience the service provided by the market place provider, and/or a particular carrier, thereby encouraging the user to buy service plans when the gift is used up. In at least one embodiment, the server might choose to split the services that were gifted into several prepaid plans and gift new prepaid plans to different users and/or combine multiple gifts from different users into one prepaid plan. For example if 750 MB data is gifted by one user, the server (or carrier) may split the 750 MB into three 250 MB prepaid plans. In an embodiment, the validity of the new gifted plans will be the same period as that of the original plan. In at least one embodiment, the server may choose to allow the gifter to choose the gift (amount, etc.)

In step 610, the server receives a selection of a gift option from the user.

In step 612, the server sends a gift account to the user that is the gift recipient.

In an embodiment, each of the steps of method 600 is a distinct step. In another embodiment, although depicted as distinct steps in FIG. 6, step 602-612 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

FIG. 7A shows a flowchart of an embodiment of method 700 for a carrier to choose what sorts of plans the carrier would like to offer, via server 150 from the point of view of the carrier.

In step 702, the carrier sends information identifying the carrier to server 150. The carrier may send the information as part of enrolling and/or signing in to the market place that is being run by server 150.

In step 703, the carrier receives information from server 150 about the plans that the carrier offers to users, via the market place running on server 150.

In step 704, the carrier sends a request for users to select the service options that the carrier would like to offer to the user. The service options may include a variety of prices, data, lengths of service, plans, etc. that the carrier offers for the user to choose. Optionally, the carrier may choose whether to participate in offering gifting options to the user. In an embodiment, the gifting options chosen by the carrier may be different than the gifting options that the market place offers whether or not the carrier chooses to offer gifting options on its own.

In step 706, the carriers receive an updated copy of the plans offered by the carrier.

In an embodiment, each of the steps of method 700 is a distinct step. In another embodiment, although depicted as distinct steps in FIG. 7, step 702-706 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

FIG. 7B shows a flowchart of an embodiment of method 730 for a carrier to choose what sorts of plans the carrier would like to offer, via server 150 from the point of view of the server 150.

In step 732, the server 150 receives the carrier information. The user may send the information as part of enrolling and/or signing in to the server 150.

In step 733, the server sends information to the carrier about the details of the plans that the carrier currently offers to users, with pages having fields and/or selections for the carrier to choose from that relate to the pricings and services offered by the carrier, via server 150. The account information may also include the carrier's financial account information with the market place of server 150.

In step 734, the server receives a request to update service options offered by the carrier from the carrier. Available service options may include prices, plans, etc. that the user may choose. The request received may be a page with fields filled in indicated changes to the plans offered by the carrier. The available options may also include an option for gifting unused portions of services purchased. The request may also include options related to gifting unused portions of plans purchased.

In step 736, the server updates the plans of that carrier that are offered to users.

In step 738, the server sends an updated appropriate copy of the plans offered by server 150 on behalf of the carrier.

In an embodiment, each of the steps of method 730 is a distinct step. In another embodiment, although depicted as distinct steps in FIG. 7B, step 732-742 may not be distinct steps. In other embodiments, method 730 may not have all of the above steps and/or may have other steps in addition to or instead of those listed above. The steps of method 730 may be performed in another order. Subsets of the steps listed above as part of method 730 may be used to form their own method

FIG. 7C shows a graph of how the pages are connected to one another for system 100. The page connections may include sign-in page 750, home 752, Networks 754, gifting information 755, accounts 760 which includes gifter 770, gift recipient 772, and carrier 774. In other embodiments, connections may include additional components and/or may not include all of the components listed above.

Sign-in page 750 functions to allow the user to sign-in. Sign-in page 750 includes links/connections to home page 752 (see also FIG. 2B 252).

The home page 752 can be accessed from the sign-in page 750. Home page 752 has connections to at least enrollment page, accounts page, networks page, and gifting information page.

The networks page 754 can be accessed from the home page 752. Networks page 554 functions to provide the user with useful information about current, past and potential networks for one or more locations. Networks page 754 includes connections/links to available networks, previous networks, and search pages. Networks page 754 may also include connections to home page 752.

The accounts page 760 can be accessed from the home page 752. Accounts 760 functions to provide the user with information about all of the user's current and past accounts. Accounts page can contain connections/links to subscriptions page, purchases page, information page, and SIM list page. Accounts 760 may also include connections to home page, networks and settings. Accounts page 760 can contain information and links to accounts for all users including gifters, gift recipients, and carriers.

Gifter page 770 may provide information about the gifter's accounts, gift points, rewards, etc. Gifter page 770 can include links and search functions that allow the gifter to gift part or all of the gifter's account for a specific carrier.

Gift recipient page 772 provides information about the gift recipient's accounts, gift points, rewards, etc. Gift recipient page 772 can include links and search functions that allow the gift recipient to obtain a gift for a specific carrier.

FIG. 7D shows a graph 780 of an embodiment of how the pages of a carrier user interface (which may be a web based GUI or an application). The pages connections may include sign-in page 781, home 782, carrier account page 786, update plans page 788, individual pages 790, and business pages 792. In other embodiments, graph 780 may include additional components and/or may not include all of the components listed above.

Sign-in page 781 functions to allow the carrier to sign-in. Sign-in page 780 allows the user to sign-in if the user has an account or to create an account if the user does not have an account. Sign-in page 781 includes connections to a home page. Sign-in page 781 may lead the user to the home page. Links on the home page may be visible to the user prior to signing-in or creating an account, but may be nonfunctional until after the user signs in.

The home page 782 can be accessed from the sign-in page 781 or automatically presented to the user after the user signs-in. In an embodiment, home page 782 and sign-in page 780 may be the same or similar except sign-in page 780 present a sign-in box to the user that disappears after successfully signing-in. The other links of the page may be inactive while the sign-in box is still present and may be active after successfully signing in and the sign-in box disappears. Home page 782 may include connections to pages for individual consumers of services, for business consumers of services, for a carrier to update plans offered to consumers and for a carrier to view the carrier's account with the marketplace provider. Optionally, there may be further enrollment pages for a new carrier that does not currently offer plans on the marketplace server and/or one or more settings pages via which the carrier may enter and/or edit the carriers settings, such as the user names and passwords of users authorized to access the carrier's pages.

The account page 786 can be accessed from the home page 782. Accounts page 782 functions to provide the carrier with information about all of the carrier's account with the marketplace provider. Accounts page may show revenue of the carrier broken down according the plan offered and the month that the revenue was received. Accounts page may also include a link showing any payments or fees charged to the carrier by the market place provider and/or charged by the carrier to the market place provider and whether or not those fees have been paid. Accounts 780 may also include connections to the home page, update plan, and settings. In an embodiment, the settings may be initially entered as part of creating an account and/or enrolling in a program, and then later edited, via a settings page. Accounts page 780 can contain information and links to accounts for all services the carrier may be enrolled in, including gifting, long distance, advertisements, etc.

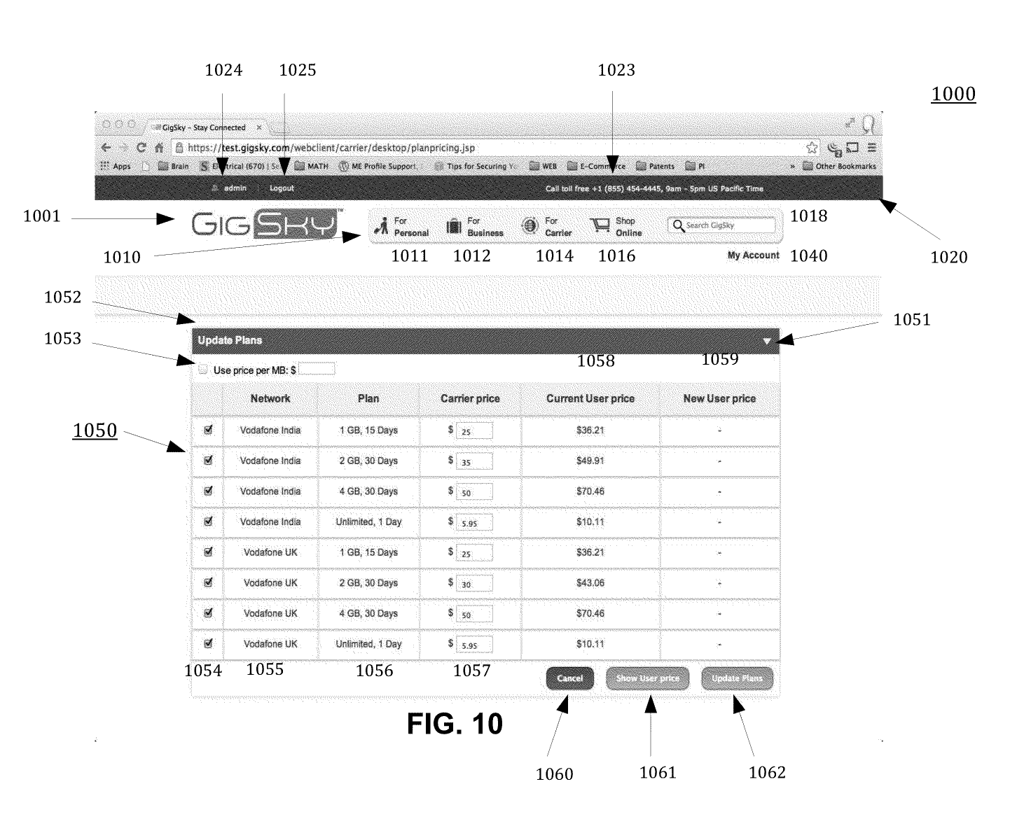

Update plans page 788 functions to allow the carrier to update plans associated with the one or more services. For example, update plans page 788 may allow the carrier to change the prices for various plans (the update plans page will be discussed further in conjunction with FIGS. 10 and 11).

Individual pages 790 are a group of pages for individual consumers of plans, via which individual consumers may purchase plans, via server 150, on any of carriers 102a-n. Home page 782 includes a link to individual pages 790. Business pages 792 are a group of pages for business consumers of plans, via which businesses may purchase plans, via server 150, on any of carriers 102a-n. Home page 782 includes a link to business pages 792.

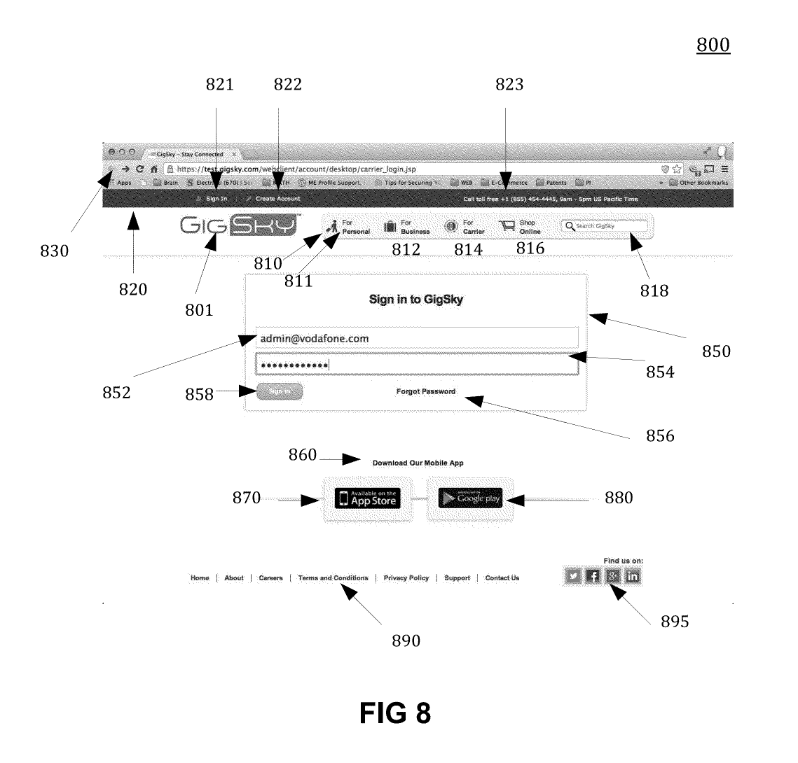

FIGS. 8-13 are screenshots of pages of a graphical user interface or application that allows carriers to access the system for all of the services it provides, including gifting, and selecting between a variety of phone services in various locations.

FIG. 8 shows an example of a sign-in/sign-up page 800 for a service that provides mobile phone service. The sign-in/sign-up page 800 may include a company title area 801, a store bar 810 with a personal button 811, a business button 812, a carrier button 814, a shop online button 816, and a search window 818. The sign-in/sign-up page 800 may include a pre-sign-in navigation bar 820, with a sign-in button 821, a create account button 822, and contact information button 823. The sign-in/sign-up page 800 may also include a webpage bar 830, a sign-in window 850 having an field 852 user identifier field 852, a password field 854, a sign in enter button 858, and a forgot password link 856. The sign-in/sign-up page 800 may also include a download link 860, an app store link 870, a play link 880, a company information bar 890, and a social network link 895. In other embodiments, the page 800 may not have all of the elements listed and/or may have other elements in addition to or instead of those listed.

The company title area 801 provides the title of the company sponsoring the page, the market place provider, which is the provider of the marketplace mobile phone service. The company title 801 in the example of FIG. 8 is “GIGSKY.” The company title 801 may also include some information about the company and/or webpage in addition to the title. Company title 801 may also include a company icon and/or logo.

The store bar 810 (which may includes a personal button, a business button, a carrier button, a shop online button, and a search window) functions to allow a user of the system to find other parts of the user interface where the user may want to purchase products from the marketplace provide, via server 150. A user of the system may be a carrier, a consumer of wireless services, a gifter, or a gift recipient.

Personal button 811, when selected may bring the user to a portion of the interface in which the user can manage a personal phone service account. For example, the user may use the pages related to personal button 811 to view accounts for personal wireless service with different carriers, purchase service for a personal phone from one or more of carriers 102a-n, top-up personal accounts that have low balances, and/or gift remaining balances on the personal accounts with carriers 102a-n.

Business button 812, when selected, may bring the user to a portion of the interface in which the user can manage a business wireless service account. For example, the user may use the pages related to business button 811 to view accounts for business wireless service with different carriers, purchase service for a business phone from one or more of carriers 102a-n, top-up business accounts that have low balances, and/or gift remaining balances on the business accounts with carriers 102a-n. Business accounts may have different levels of access for different users. A user in the roll of an administrator may have authorization to purchase new services, top-up services, gift services for any user account associated with the business. The administrator may have authorization to transfer service between two users of the business that the administrator is associated with. Another user having a lower level of access may only be able to purchase services for the user's own account that is associated with the business and may or may not have the authorization to gift unused services to another user account of the same business. Another user having yet a lower level of access may only be able to view account balances for the account that that user uses, but not have any authorization for purchasing or gifting services.

Carrier button 814, when activated, may bring the user to a set of interface pages that allow the user to change the plans offered by that user and view the carrier's revenues, fees paid or owed by the carrier to the market place provider and/or fees paid or owed by the market place provider to the carrier.

Shop online button 816, when activated, may bring the user to a page for purchasing desired products and/or services. Search window 818 may allow the user to enter a string to find different features of the site. If the user is a consumer of services provided by the carriers 102a-n, server 150 of the market place, search window 818 may be used for searching for different plans by different carriers available in different locations.

The pre-sign-in bar 820 is a bar that may be used for signing-in and/or creating an account. Sign-in button 821 may be used by a user already having an account to sign-in. Activating sign-in button 821 may cause assign-in dialog box to be displayed.

Create account button 822, when activated, may cause the user to be brought to a part of the user interface for creating an account and entering initial values for various settings.

Contact information button 823, when activated, may cause a page to be displayed having contact information for the marketplace provider, such as one or more physical addresses, e-mail addresses, social media addresses, instant message addresses and/or phone numbers.

Contact information button 823 may also provide information about the “store hours” or the time that the user can telephone and speak to a representative of the marketplace provider (such as “9 am-5 pm US Pacific Time”).

The webpage bar 830 is an example of a browser menu or toolbar, which may provide to access the system GUI. Alternatively, a user can download an app and interact with server 150, via the app.

The sign-in window 850 field 852 password field allows a user to sign in. Sign-in window 850 may include one or more fields for entering user information that may be used for authenticating the user.

User identifier field 852 may include a field for entering a user identifier. In the example of FIG. 8, the user's e-mail address is used as the user identifier. In other embodiments, the user identifier may include other combinations of symbols and characters.

Password field 854 may include a field for entering a password. The password may be necessary to ensure that the user is authorized to user the account having the user identifier entered into user identifier field 852.

Sign-in button 858, when activated, may initiate an authentication process in which server 150 authenticates the user to determine whether or not to grant access. Sign-in button 858, when activated, may cause the user identifier and password entered into user identifier field 852 and password field 854 to be sent to server 150 for authentication.

Forgot password link 856, when activated, may bring the user to a page for entering other credentials that may be used to authenticate the user.

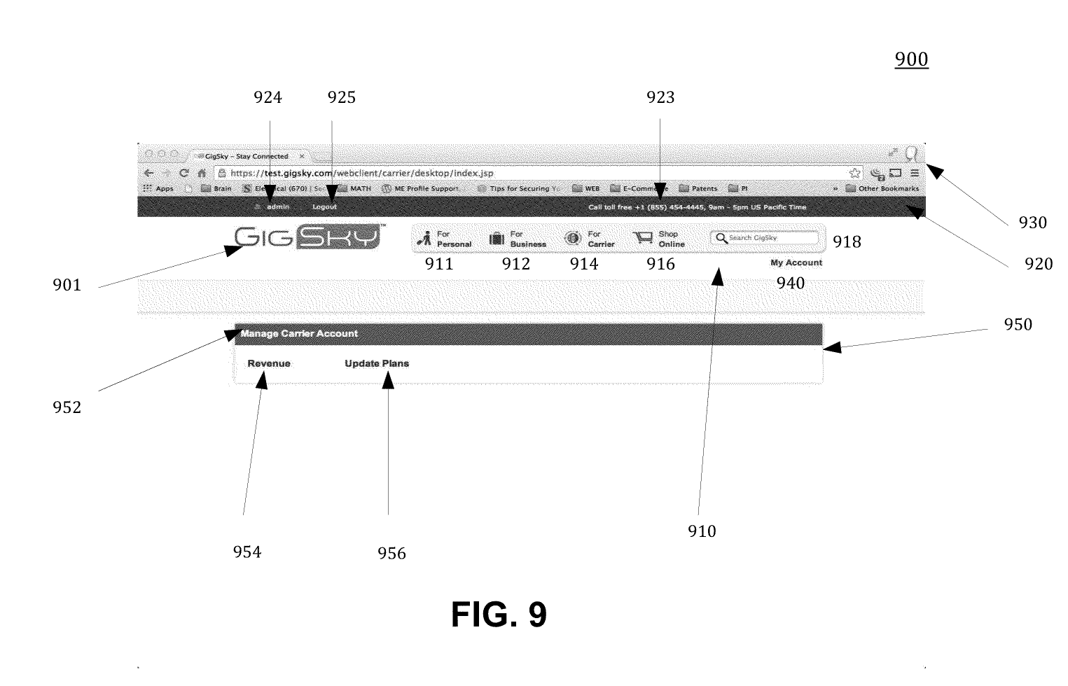

The download link 860, when activated may cause an application for interfacing with server 150 to be downloaded. The application may have similar pages as are available, via GUI 170 (which may include the webpages of FIGS. 9-13).

The app store link 870 when activated (e.g., by clicking) sends the user to a page where the user can purchase apps, which may include application 169. For example, clicking on app store link 870 may bring the user to the Apple app store, another app store, or a menu of different ap stores to choose from.

The play link 880 functions to provide a link to another site that allows users to download mobile apps. In the example of FIG. 8, play link 880 is a Google play link. In other embodiments another play link may be provided, or the play link may bring the user to a menu of play links by different providers to choose form.

The company information bar 890 includes a number of links that are specific to the company or network. The company information bar in FIG. 8 provides the user with links to the company's home page (home), a page giving more information about the company (about), a career page (career), a terms and conditions page, a privacy policy page, a support page where the user can get help via telephone or email, and a contact us page that provides the user with contact information for the company. The company information bar 890 also includes a button (about) for viewing more information about the site and the service provided.

The social network link 895 provides one or more links to social networks (e.g., Twitter®, Facebook®, Google®, and LinedIn®). The social network link 895 gives the user the option of gifting and/or signing-in via a social network. When activated, the social network link 895 sends the user to a page where the user can sign in or sign up for the social network. FIG. 8 may also include a button for signing up to the website and the service provided by the website for the first time (a sign-up button).

FIG. 9 shows a screenshot of an example of a page 900 for adding time and/or data by a carrier using the system 100. The page for adding time and/or data may include a company title area 901, a store bar 910 with a personal button 911, a business button 912, a carrier button 914, a shop online button 916, and a search window 918, a gift app bar 920, with a sign-in button 921, a create account button 922, and contact information button 923, a webpage bar 930, an account window 950, having a window title 952, a revenue link 954, and an update plans link 956. In other embodiments 900 may not have all of the elements or features listed and/or may have other elements or features instead of or in addition to those listed.

The company title area 901, a store bar 910, personal button 911, business button 912, carrier button 914, shop online button 916, search window 918, gift app bar 920, sign-in button 921, create account button 922, contact information button 923, and webpage bar 930 are embodiments of title area 801, store bar 810, personal button 811, business button 812, carrier button 814, shop online button 816, search window 818, pre-sign-in bar 820, sign-in button 821, create account button 822, contact information button 823, and webpage bar 830, respectively, which have all been discussed with reference to FIG. 8 as company.

Account window 950, provides links for accessing information about the carrier's account and different pages of to the carrier's account. For example a specific carrier (e.g., Vodafone India) may use pages linked to account window 950 to access pages for looking up how many people signed up for services provided by Vodafone India, how much the carrier and/or the marketplace provider paid to one another, how much the carrier paid for ads or placement in the system. Account window 950 may link to pages where the carrier can make changes to plans offered to consumers and view revenues resulting from those plans.

Window title 952 provides is a title for the window of account widow 950, which briefly describes the purpose of account window 950. In the Example of FIG. 9, the window title of account window 950 is “Manage Carrier Accounts.”

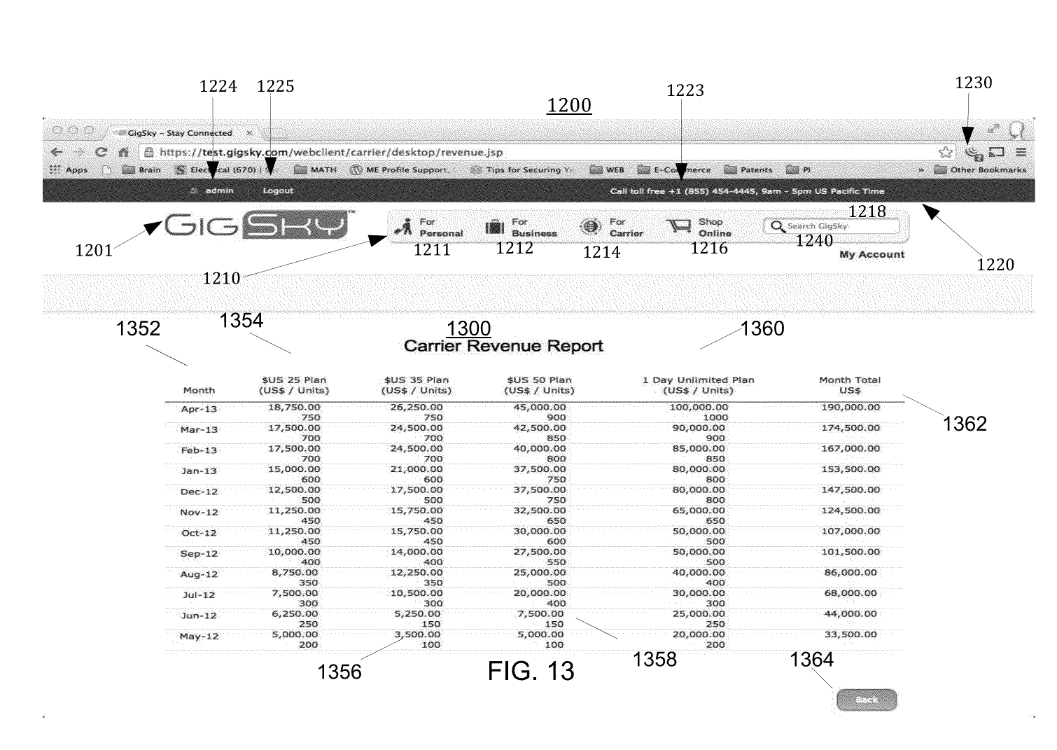

Revenue link 954, when activated brings the user to one or more pages where the user may view revenue resulting from the different plans that the carrier offers to consumers of wireless services (an example of a revenue page will be discussed in conjunction with FIG. 13, below).

Update plans link 956 can be activated to allow the carrier to update plans (an example of a page for updating plans will be discussed further in conjunction with FIGS. 10 and 11, below).

FIG. 10 shows a screenshot of an example of a carrier plans page 1000 listing plans offered by a carrier. The carrier plans page 1000 may include a company title area 1001, and a store bar 1010 having a personal button 1011, a business button 1012, a carrier button 1014, a shop online button 1016, and a search window 1018. The carrier plans page 1000 may include a gift app bar 1020, with a sign-in button 1021, a create account button 1022, and contact information button 1023. The carrier plans page 1000 may include a webpage bar 1030. The carrier plans page 1000 may include a plans window 1050, having a title 1052, an arrow 1051, a price basis 1053, a plan indication column 1054, a network column 1055, a plan column 1056, a carrier price column 1057, a current user price column 1058, a new user price column 1059, a cancel button 1060, a show user price button 1061, and an update plans button 1062. In other embodiments 1000 may not have all of the elements or features listed and/or may have other elements or features instead of or in addition to those listed.

The company title area 1001, store bar 1010, personal button 1011, business button 1012, carrier button 1014, shop online button 1016, search window 1018, gift app bar 1020, sign-in button 1021, create account button 1022, and contact information button 1023, a webpage bar 1030 are embodiments of title area 801, store bar 810, personal button 811, business button 812, carrier button 814, shop online button 816, search window 818, pre-sign-in bar 820, sign-in button 821, create account button 822, contact information button 823, and webpage bar 830, respectively, which have all been discussed with reference to FIG. 8.

Plans window 1050 provides a listing of all of the plans offered by the current carrier, which may include information about the manner in which the carrier and plan are listed in marketplace the price charged by the carrier price, current price charged to the user, and new price charged to the user price. New user price column only changes if the carrier makes a change to a plan, more specifically a change to the carrier price. For example, in FIG. 11, the carrier made a change to the carrier price for each of the plans and the new user price is indicated.

Title 1052 gives a title for the main window on the page of FIG. 10, which briefly describes the purpose of the window. In the example of FIG. 10, the title is “Update Plans” indication that the carrier may update the services offered to the user via plans window 1050. Arrow 1051 is a link that allows the user to switch to another page. For example, selecting arrow 1051, may allow the user to view other account information that is of interest to the carrier or to see the next page of plans offered to consumers.

Price basis 1053 is a combination of fields that allows the user to select a basis for determining prices. In the example of FIG. 10, price basis 1053 includes a check box, which if checked causes the basis of pricing of price 1053 to be applied to all plans. In the example of FIG. 10, when the check box is checked, the basis of the pricing is the units of data that the user may consume. In the example of FIG. 10, a field is provided for entering the price per unit of data that the user purchases. If the user purchases 1 MB of data, after the user has transferred 1 MB of data, the account is depleted unless replenished by the user.

Plan participation column 1054 is a column of fields in which the carrier may enter whether the carrier want to offer a plan of the nature described in the rest of the row. In the example of FIG. a check box is used to indicate whether the carrier desires to offer the corresponding plan, but in other embodiments, an x, a true/false indicator or yes/no or another type of field may be used instead. Marketplace provider may have a set of preconfigured plans in which the data available for the user and the duration of the plan is already specified. The Carrier just needs to determine whether the carrier wants to offer such a plan (e.g., by checking the check box of the plan participation field) and, if the carrier decides to participate in that plan, the price at which the carrier will be compensated for that plan.

Network column 1055 indicates the network associated with the plan being offered. For example, the same carrier may own different networks in different locations, and each may offer different prices and units of service that may be purchased. In the example of FIG. 10, Vodafone has one network, Vodafone India, which offers service in India, and another network, Vodafone UK, which offers service in the UK.

Plan column 1056 lists details the plans. In the example of FIG. 10, each plan lists the amount of data that the user is entitled to transfer and the amount of time that the plan lasts. In an embodiment, if the amount of time expires or the amount of data is consumed (whichever occurs first), the account expires.

Carrier price column 1057 includes price at which the carrier offers the plan. In an embodiment, carrier price column 1057 may include one field for each plan. The user may individually enter a price for each of the plans offered by the carrier in the fields of carrier price column 1057.

Current user price column 1058 may list the price that is currently offered to the consumer of the wireless service. The current user price may be different than the current price of the carrier in carrier price column 1057. For example, the marketplace provider may offer the plan at a higher price than the carrier asks for, and the difference in price may be used to cover expenses of the marketplace provider and/or may cover a profit that the market place provider collects. Alternatively, at times the marketplace provider may offer a plan of a carrier at a lower rate than the carrier is being paid (thereby potentially incurring a loss in revenue whenever a user purchases the plan) as a promotional offer. In an embodiment, as a result of gifting, in some circumstances, the marketplace provider may be able to sell a plan at a lower rate than the carrier price, because as a result of the marketplace provider reselling gifted services, the market place provider is able to effectively sell, part of the same plan twice.

New user price column 1059 indicates what the user price will be changed to as a result of the carrier changing the carrier price listed in carrier price column 1057.

Cancel button 1060, when activated, causes the changes made to the plans offered, via update plan 1052, to be cancelled, which thereby allows the carrier to cancel the change if the carrier decides not to update the plans. Once activated, the carrier may be returned to the home page, or to the carrier's account page.

The show user price button 1061, when activated, causes the user price to be calculated based on the carrier price entered into carrier price column 1057, and causes the user price calculated to be displayed in new user price column 1159.

Update plans button 1062, when activated, accepts the carrier's change(s) to the plan or plans. In an embodiment, the current user price is not updated until after the change is reviewed and approved by a representative or employee of the marketplace provider, which may require a human to review the proposed carrier prices entered by the carrier. Alternatively, server 150 may automatically approve or reject the carrier plan prices entered by the carrier. In an embodiment, after activating the update plans button 1062 and after the marketplace provider approves, new user price becomes the current user price. For example, in an embodiment, if the user already activated show user price button 1061 (and consequently, the new user price column is current), then the new user price column 1059 becomes the current price in current user price column 1058. However, if update plans button 1062 is activated without updating new user plan price 1059, then current user price updated to the appropriate value regardless of the value in current user price 1058.

FIG. 11 shows another screenshot of an example of a page 1100 listing plans for a carrier subscribed to system 100. The page is identical to FIG. 10 except that the carrier prices and/or plans have been changed by the carrier. See, for example, Vodafone India plan with 1 GB, 15 days has been changed from a carrier price of $25 (in FIG. 10) to a carrier price of $20 in FIG. 11. New user price column only changes if the carrier makes a change to a plan, more specifically a change to the carrier price. For example, in FIG. 11, the carrier made a change to the carrier price for each of the plans and the new user price is indicated for each of the plans. Thus, FIG. 11 is an example of what happen if the carrier activated the show user price button 1161.

FIG. 12 shows a screenshot of an example of a page 1100 shown to the carrier after the carrier has changed the prices and/or plans in FIGS. 10 and 11 used in system 100. The page 1200 may include a company title area 1201, a store bar 1210 with a personal button 1211, a business button 1212, a carrier button 1214, a shop online button 1216, and a search window 1218, a gift app bar 1220, with a sign-in button 1221, a create account button 1222, and contact information button 1223, a webpage bar 1230, an update window 1250, having an arrow 1251, a window title 1252, an information section 1253, and an acknowledgement button 1254. In other embodiments 1200 may not have all of the elements or features listed and/or may have other elements or features instead of or in addition to those listed.

The company title area 1201, store bar 1210, personal button 1211, business button 1212, carrier button 1214, shop online button 1216, search window 1218, gift app bar 1220, sign-in button 1221, create account button 1222, contact information button 1223, webpage bar 1230 are embodiments of title area 801, store bar 810, personal button 811, business button 812, carrier button 814, shop online button 816, search window 818, pre-sign-in bar 820, sign-in button 821, create account button 822, contact information button 823, and webpage bar 830, respectively, which have all been discussed with reference to FIG. 8.

An update window 1250 is a box that appears after the user has activated the update plans button (1062 or 1162) in FIG. 10 or 11. In an embodiment, update window 1250 confirms that server 150 received the proposed update to the plans of the carrier that are offered to consumers, and informs the carrier that the updates will not be visible until the proposed updates are confirmed (e.g., approved) by the marketplace provider.

The arrow 1251, when activated provides a menu of other carrier pages and/or other pages of the interface that the user may want to view.

Window title 1252 is “update complete” and provides information about what the window that appears is providing. In this case information about the update.

Information section 1253 provides more information about the update, such as when the update will be reflected in the carrier plan page. For example, the embodiment of FIG. 12, information section 1253 includes the caption, “new prices will be reflected after confirmation by GigSky.”

Acknowledgement button 1254, when indicated, provides confirmation that the carrier accepts the update and that the carrier received an update message. Acknowledgement button 1254, when activated, indicates that the carrier has read the content of update window 1250. Also, in an embodiment, after activating acknowledgement button 1254, the user is returned carrier plan page 1000.

FIG. 13 shows a screenshot of an example of a revenue page 1300 listing plans offered by a carrier. The carrier plans page 1300 may include a company title area 1301, and a store bar 1310 having a personal button 1311, a business button 1312, a carrier button 1314, a shop online button 1316, and a search window 1318. The carrier plans page 1300 may include a gift app bar 1020, with a sign-in button 1321, a create account button 1322, and contact information button 1323. The carrier plans page 1000 may include a webpage bar 1330, date column 1352, first plan column 1354, second plan column 1356, third plan column 1358, fourth plan column 1360, and total column 1362. In other embodiments 1300 may not have all of the elements or features listed and/or may have other elements or features instead of or in addition to those listed.

The company title area 1301, store bar 1310, personal button 1311, business button 1312, carrier button 1314, shop online button 1316, search window 1318, gift app bar 1320, sign-in button 1321, create account button 1322, and contact information button 1323, a webpage bar 1330 are embodiments of title area 801, store bar 810, personal button 811, business button 812, carrier button 814, shop online button 816, search window 818, pre-sign-in bar 820, sign-in button 821, create account button 822, contact information button 823, and webpage bar 830, respectively, which have all been discussed with reference to FIG. 8.

Page 1300 shows a month-by-month, plan-by-plan breakdown of revenues. Date column 1352 shows the period to time during which the revenue of the same row was collected. In the example of FIG. 13, the time period is one month, and the date listed is the month and year of the time period listed in the same row. Each of the columns first plan column 1354, second plan column 1356, third plan column 1358, and fourth plan column 1360 correspond to a different plan offered by the carrier. In each field of each column is revenue for the month and plan associated with the field. In the example of FIG. 13, corresponding to each month and plan, a value representing the amount of cash gained is displayed as well as an indication of the number of units purchased.

Totals column 1362 shows the total revenue for each month for all of the plans combined and the total number of units of data combined from each plan for that month that was purchased by users.

Back button 1364, when activate brings the user back to the prior page that the user was viewing.

### ALTERNATIVES AND EXTENSIONS

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
receiving, at a server from a user device, a request to purchase a prepaid wireless plan on behalf of a user, the server including at least a processor system having one more or more processors and a memory system;
in response, the processor system, adding the wireless service purchased to an account of the user and storing account information reflecting the purchase in the memory system of the server;
sending, from a server to a user device, which when consumed by the user device causes a page to be displayed on the user device with an option for the user to give away an unused portion of a prepaid wireless plan purchased;
receiving, at the server, a request to give away a portion of the prepaid plan purchased; and
sending from the server, an offer to another user for prepaid wireless service, that includes at least a portion of the prepaid wireless service given away.

2. The method of claim 1, wherein the option to give a portion of the prepaid plan is offered to the user in exchange for promotional offer.

3. The method of claim 1, wherein the user is offered a choice to give part of the unused portion of the prepaid service remaining in a plan and choice to give way all of the unused portion of the prepaid service remaining in a plan.

4. The method of claim 1, wherein in response to the request to give away the portion of the prepaid plan, the server computing an amount by which to lower the user's balance as a result of the give away, and the server storing the a change to the user account based on the computing.

5. The method of claim 1, wherein the amount given away is added to a pool of prepaid wireless service that was given away by multiple users.

6. The method of claim 5, further comprising determining, by the server system, to whom and how much the balance is to be offered.

7. The method of claim 6, wherein the gifting system can split the balance into parts and gift each part to a different user.

9. The method of claim 1, wherein the service given away expires based on when the user originally purchased the service given away.

10. The method of claim 1, wherein amount given away offered to the other user as a promotional offer.

11. The method of claim 1, the sending from the server, the offer to another user for prepaid wireless service that was given away, includes offering the prepaid wireless service at a discounted rate.

12. The method of claim 1, the other user being a charity and the sending from the server, the offer to another user for prepaid wireless service that was given away, includes offering the prepaid wireless service to the charity.

13. The method of claim 1, the other user being a user in an under developed region, and the sending from the server of the offer to another user for prepaid wireless service that was given away, includes offering the prepaid wireless service to the in the under developed region.

14. The method of claim 1, the other user being a user that was specified by the user that gave away the prepaid service, and the sending from the server of the offer to another user that prepaid wireless service that was given away, includes offering the prepaid wireless service to the in the user that was specified by the user that gave away the prepaid service.

15. The method of claim 1, further comprising receiving at the server a request from the user a selection of the other user from a list of users stored by the user that is giving away the prepaid service.

16. The method of claim 1, the request to purchase the prepaid plan including at least to purchase a service from a service that requires an IMSI and Ki, that the user does not currently posses, where the carrier is a separate entity from the server; and
the sending the IMSI and Ki from the server to the user device.

17. A method comprising:
sending, from a user device to a service, a request to purchase a prepaid wireless plan on behalf of a user, the user device including at least a processor system having one more or more processors and a memory system;
in response, receiving at the user device, an indication that the wireless service purchased is being added to an account of the user and storing account information reflecting the purchase in the memory system of the server;
receiving, from the server at a user device, a page with an option for the user to give away an unused portion of a prepaid wireless plan purchased;
sending, from the user device to the server, a request to give away a portion of the prepaid plan purchased; and
receiving, at the user device from the server, a confirmation that the portion of the prepaid wireless service given away.

18. A server comprising:
a processor system including at least one or more processors; and
a memory system with which the processor system communicates, the memory system including at least one or more non-transitory computer readable media that store one or more machine instructions, which when invoked cause the processor to perform a method including at least
receiving, at the server from a user device, a request to purchase a prepaid wireless plan on behalf of a user, the server including at least a processor system having one more or more processors and a memory system;
in response, the processor system, adding the wireless service purchased to an account of the user and storing account information reflecting the purchase in the memory system of the server;
sending, from a server to a user device, a page to the user device with an option for the user to give away an unused portion of a prepaid wireless plan purchased;
receiving, at the server, a request to give away a portion of the prepaid plan purchased; and
sending from the server, an offer to another user for prepaid wireless service, that includes at least a portion of the prepaid wireless service given away.
